(19) United States
(12) Patent Application Publication
(10) Pub. No.: US 2026/0030286 A1
(43) Pub. Date: Jan. 29, 2026

(54) MULTIMODAL AI-BASED SEARCH FOR DIGITAL ASSETS

(71) Applicant: NVIDIA Corporation, Santa Clara, CA (US)

(72) Inventors: Rafal WYTRYKUS, Zug (CH); Artem ROZANTSEV, Zurich (CH); Nikola SPASOJEVIC, Zurich (CH); Andrew J. COMO, Lillington, NC (US); Ling QI, Campbell, CA (US); Todd John GALDA, Port Moody (CA)

(21) Appl. No.: 18/943,605

(22) Filed: Nov. 11, 2024

Related U.S. Application Data
(60) Provisional application No. 63/676,425, filed on Jul. 28, 2024.

(51) Int. Cl. G06F 16/51; G06F 16/55; G06F 16/56; G06F 16/901

(52) U.S. Cl. CPC G06F 16/51; G06F 16/55; G06F 16/56; G06F 16/9024

(57) ABSTRACT

Embodiments of the present disclosure relate to multimodal AI-based search for digital assets via an indexing and/or search pipeline. With respect to the indexing pipeline, some embodiments obtain first data and second data associated with a first digital asset. Such data represents different data types or modalities of the same digital asset. After obtaining the first and second data, some embodiments then generate a composite index. After the composite index is built such index can then be used to execute a query via the search pipeline. To execute the query some embodiments compute a relevance score for each digital asset, of multiple digital assets, based at least in part on a measure in which each digital asset satisfies one or more parameters or conditions for two or more data types of the query. Various embodiments then rank each digital asset and present one or more associated indicators.

### CROSS-REFERENCE TO RELATED APPLICATIONS

This application claims the benefit of U.S. Provisional Application No. 63/676,425, entitled “Artificial Intelligence Agentic Systems for Multi-Modal Asset Search, Scene Understanding, and Automated Scene Validation for Synthetically Generated Content,” filed on Jul. 28, 2024, the entirety of which is incorporated herein by reference.

### BACKGROUND

Digital asset management and search refers to the processes and tools used to store, organize, and retrieve digital assets (e.g., a 3D model of an object) and related data. This functionality is fundamental in industries such as gaming, virtual reality (VR), film, architecture, and product design. These technologies are designed to help users efficiently curate and manage collections of digital assets, ensuring that digital assets can be easily accessed, reused, and incorporated into various projects or workflows. For example, a user may retrieve and select from some or all 3D models of wooden chairs in a kitchen scene by searching for the material and scene context within a large digital asset library.

However, Digital assets and corresponding queries are becoming increasingly complex. For example, 3D assets carry a lot of information of different types, are usually composed of nested assets, and are related to one another in multiple dimensions. 3D assets often include intricate geometries, material properties, and spatial relationships, and may be stored in formats like USD (Universal Scene Description) that allow for rich representations of objects and scenes. As datasets grow even larger and more complex, with increasingly diverse digital assets and sophisticated queries, the ability to efficiently search and retrieve digital assets based on multiple criteria-such as visual similarity, spatial arrangements, and material properties-becomes challenging.

### SUMMARY

Embodiments of the present disclosure relate to execution of multimodal AI-based searching of digital assets via an indexing and/or search pipeline. With respect to the indexing pipeline, some embodiments first obtain first data and second data associated with a first digital asset. Such data represents different data types or modalities of the same digital asset. For example, the first data may represent graph data of an asset graph, where nodes (vertices) represent individual elements (objects) in a scene, such as chairs, tables, walls, etc. Edges (connections) represent relationships or dependencies between the objects, such as hierarchical relationships (e.g., a table node as the parent of chair nodes) and spatial dependencies (e.g., an edge between two nodes that are close to each other or part of the same scene context). In another example, the second data may represent a multimodal embedding (e.g., a Contrastive Language-Image Pretraining (CLIP) embedding) from an image that represents the first digital asset. The multimodal embedding is a vector representation that encodes data from a text modality and an image modality into a shared embedding space.

After obtaining the first and second data, some embodiments then generate a composite index. A composite index is a centralized data structure that organizes and links (e.g., via a pointer or key) data from multiple sub-indices. Each sub-index stores information related to a specific data type or modality (e.g., visual data, text data, spatial data, or material data) for a respective digital asset. To generate the composite index, some embodiments store the first data in a first sub-index and the second data in a second sub-index. Some embodiments then associate the first sub-index and the second sub-index to a single asset identifier representing the identity of the first digital asset. The single asset identifier is a reference point to retrieve at least one of the first data or the second data for a query associated with the first digital asset. For example, the single asset identifier may act as a common key to associate and retrieve related data across multiple sub-indices, ensuring the data from different modalities (e.g., visual and textual) corresponds to the same asset.

With respect to the search pipeline, after the composite index is built, such index can then be used to execute a query. In some embodiments, the query includes one or more query parameters or conditions associated with two or more data types/modalities. To execute the query some embodiments compute a relevance score for one or more (e.g., each) digital assets among multiple digital assets (representing search result candidates), based at least in part on a measure in which any of the one or more digital asset satisfies the one or more parameters or conditions for the two or more data types. For example, some embodiments first parse the query and identify parameters associated with multiple data types (e.g., visual data: red color; text data: wooden material and object type (chair), spatial data: positioned near a table, scene context: placed in a dining room). After each query parameter is mapped to the appropriate sub-index, various embodiments then retrieve the data (e.g., the graph data and the multimodal embeddings described above) from the sub-indices using the asset identifier. For at least one (e.g., each) digital asset, some embodiments retrieve and aggregate data from the sub-indices. Once all relevant data is aggregated for an asset, some embodiments then compute the relevance score based on how well a (e.g., each) digital asset satisfies the query's parameters across the multiple data types. This is done by assigning a score to a parameter and combining them. For example, using the illustration above, with respect to a visual data score (Red Color), a query processor checks how well the first asset matches the visual requirement of being red. If the first asset is red, it receives a high score for this parameter. With respect to the text data score (Wooden Chair), the query processor checks if the textual metadata identifies the first asset as a “wooden chair.” If the first asset is tagged as wooden and a chair, it receives a high score for this parameter. These individual scores are combined to generate a relevance score for the first asset based on how well it matches all the query parameters across different data types. Various embodiments then rank the digital assets based at least on the query and the relevancy score for each digital asset. And based at least on the rank of each digital asset, some embodiments cause presentation, at a user device, of an indicator of at least the first digital asset.

### BRIEF DESCRIPTION OF THE DRAWINGS

The present systems and methods for sensor simulation and learning sensor models with generative machine learning is described in detail below with reference to the attached drawing figures, wherein:

FIG. 1 illustrates an example indexing and search pipeline, according to some embodiments;

FIG. 2 illustrates an example search pipeline, according to some embodiments;

FIG. 3 illustrates an example pipeline that processes and indexes digital assets into graph data structures, storing them for querying and retrieval through both general and scene-specific search queries, according to some embodiments;

FIG. 4 is a schematic diagram of an example composite index, according to some embodiments

FIG. 5 is a schematic diagram illustrating an example graph data structure that contains graph data, according to some embodiments;

FIG. 6 is a screenshot of an example user interface page illustrating execution of a proximity search, according to some embodiments;

FIG. 7 is a screenshot of an example user interface page illustrating the enforcement of spatial policies, according to some embodiments;

FIG. 8 is a flow diagram of an example process for building a composite index, according to some embodiments;

FIG. 9 is a flow diagram of an example process for executing a query to return an indicator of at least a first digital asset, according to some embodiments;

FIG. 10A is a block diagram of an example generative language model system suitable for use in implementing at least some embodiments of the present disclosure;

FIG. 10B is a block diagram of an example generative language model that includes a transformer encoder-decoder suitable for use in implementing at least some embodiments of the present disclosure;

FIG. 10C is a block diagram of an example generative language model that includes a decoder-only transformer architecture suitable for use in implementing at least some embodiments of the present disclosure;

FIG. 11 is a block diagram of an example computing device suitable for use in implementing at least some embodiments of the present disclosure; and

FIG. 12 is a block diagram of an example data center suitable for use in implementing at least some embodiments of the present disclosure.

### DETAILED DESCRIPTION

Existing digital asset management and search technologies typically require manual tagging and labeling of digital assets (like 3D models, scenes, and images). This approach is not only time-consuming, but also prone to error and inconsistency. For example, digital assets like a chair or a table need to be manually labeled as such. If a labeler uses different terms or makes mistakes when labeling, those assets might not be retrieved in a search, thereby making search retrieval inaccurate and/or incomplete. This limits the scope of search queries to only pre-tagged labels, reducing flexibility and search complexity. Complex relationships and multimodal aspects (like geometry, materials, lighting conditions) are often not tagged or cannot be effectively tagged by humans.

Many existing solutions are also designed to support single modalities. For example, there are existing solutions that operate with either natural language text tags or visual data, but cannot effectively combine both. In an illustrative example, users may be able to search for a chair by name, but not by its geometric shape, material, or spatial relationship with other objects in a scene. For instance, a simple query like “all wooden chairs in a kitchen” requires understanding both visual properties (wood texture) and contextual properties (the kitchen scene), which current solutions struggle to integrate. Search engines that, for example, rely solely on text-based inputs (tags) ignore the rich, multimodal nature of 3D assets, which include spatial relationships, object interactions, and material properties.

Traditional search engines typically use separate indices to store different types of data, such as text-based metadata or image-based searches. They do not have an integrated system that can handle queries involving complex relationships between multiple data types. Running multiple searches separately and manually combining the results is inefficient and cumbersome. For complex queries involving multiple types of data (e.g., “objects made of wood that are placed on tables”), users must perform multiple searches and manually reconcile results, which is not only time-consuming and error-prone, but unnecessarily consumes computing resources, such as computer input/output (I/O). For each individual search query, the system has to perform multiple read and write operations to access and retrieve data from different databases or storage. This increases the number of I/O operations required, which places unnecessary wear and tear on storage device components (e.g., a disk read/write head). Multiple searches generate high I/O loads due to repeated access to different datasets or indices, especially if searches access large datasets multiple times.

Various embodiments of the present disclosure employ one or more technical solutions that solve one or more of the technical problems described above and other technical problems. Various aspects are directed to multimodal AI-based search for digital assets via an indexing and/or search pipeline. With respect to the indexing pipeline, some embodiments first obtain first data and second data (and/or other data) associated with a first digital asset. Such data represents different data types or modalities of the same digital asset. For example, before obtaining the first data, some embodiments first determine spatial data (e.g., coordinates, spatial dependencies, or hierarchical relationships) of elements within the first digital asset in a universal scene descriptor (USD) data format. USD organizes 3D elements into primitives (prims), which represent objects or elements in a scene. Each prim can have transformations (such as position, rotation, and scale) that define its spatial properties in the scene. Accordingly, for instance, USD organizes objects in a hierarchical tree structure where prims can have children or descendants. Some embodiments interpret this hierarchy to understand spatial relationships between objects. Based on the spatial data, some embodiments construct a graph data structure that includes graph data, where the graph data represents the first data. For example, nodes (vertices) represent individual elements (objects) in the scene, such as chairs, tables, walls, etc. Edges (connections) represent relationships or dependencies between the objects. These can include hierarchical relationships (e.g., a table node as the parent of chair nodes) and spatial dependencies (e.g., an edge between two nodes that are close to each other or part of the same scene context). The spatial relationships are encoded in the graph, allowing the system to understand the spatial organization of the scene.

In an illustrative example of obtaining the second data, some embodiments compute a multimodal embedding (e.g., a Contrastive Language-Image Pretraining (CLIP) embedding) from an image that represents the first digital asset. The multimodal embedding is a vector representation that encodes data from a text modality and an image modality into a shared embedding space, where the multimodal embedding is included in the second data. For example, a CLIP model processes the image of the first digital asset and corresponding textual data through two separate encoders-one for the image modality and one for the text modality. The image encoder (e.g., a convolutional or transformer-based network) extracts visual features from the image, while the text encoder (e.g., a transformer-based language model) converts the associated text description into a textual feature vector. Both encoders map their respective inputs into a shared embedding space using a contrastive learning objective, where the goal is to align embeddings of matching image-text pairs closely while pushing apart embeddings of non-matching pairs. The resulting multimodal embedding is a vector representation that encodes information from both modalities, capturing semantic relationships between the image and text. This embedding is then included in the second data, enabling the system to represent and retrieve a representation of the first digital asset based on both visual and textual information in a unified way. There are additional or alternative ways that the first and second data can be derived, such as through using a vision language model (e.g., a Vision Transformer (ViT)), converting USD files to thumbnails, or the like, as described in more detail below.

After obtaining the first and second data, some embodiments then generate a composite index. A composite index is a centralized data structure that organizes and links (e.g., via a pointer or key) data from multiple sub-indices. Each sub-index stores information related to a specific data type or modality (e.g., visual data, text data, spatial data, or material data) for a respective digital asset. To generate the composite index, some embodiments first store the first data in a first sub-index and the second data in a second sub-index. For example, using the illustration described above, some embodiments store the graph data representing the spatial data in the first sub-index and also store the multimodal embedding (e.g., CLIP embedding) in the second index. Some embodiments then associate the first sub-index and the second sub-index to a single asset identifier representing the identity of the first digital asset. The single asset identifier is a reference point to retrieve at least one of the first data or the second data for a query associated with the first digital asset. For example, the single asset identifier may act as a common key to associate and retrieve related data across multiple sub-indices, ensuring the data from different modalities (e.g., visual and textual) corresponds to the same asset. In another example, some embodiments use pointers in the composite index to reference the specific locations of data within each sub-index, allowing it to quickly access and retrieve the associated data for the asset from different sub-indices.

With respect to the search pipeline, after the composite index is built, it can then be used to execute a query. Some embodiments first receive a query associated with the first digital asset. In some embodiments, the query includes one or more query parameters or conditions associated with two or more data types/modalities (e.g., visual data, text data, spatial data, or material data). For example, the query may be “a red wooden chair placed near a table in a dining room,” where the clause “red wooden chair” represents a material modality, while the clause “near a table in a dining room” represents a spatial modality.

Some embodiments then compute a relevance score for a (e.g., each) digital asset, of multiple digital assets (including the first digital asset), based at least in part on a measure in which each digital asset satisfies the one or more parameters or conditions for the two or more data types. For example, some embodiments first parse the query and identify parameters associated with multiple data types (e.g., visual data: red color, text data: wooden material and object type (chair), spatial data: positioned near a table, scene context: placed in a dining room). Various embodiments then map each query parameter to the appropriate sub-index (e.g., visual sub-index finds chairs that have visual features corresponding to the color red, text sub-index finds assets tagged as “wooden” and “chair” spatial sub-index finds chairs that are positioned near a table and located in a dining room scene).

Various embodiments then retrieve the data (e.g., the graph data and the multimodal embeddings described above) from the sub-indices using the composite index. For example, some embodiments associate the visual data, text data, and spatial data using a common asset identifier (e.g., “CHAIR001”). For each digital asset, some embodiments retrieve and aggregate data from the sub-indices. Once all relevant data is aggregated for each asset, some embodiments then compute the relevance score based on how well each digital asset satisfies the query's parameters across the multiple data types. This is done by assigning a score to each parameter and combining them. For example, using the illustration above, with respect to the visual data score (Red Color), a query processor checks how well the asset matches the visual requirement of being red. If CHAIR001 is red, it receives a high score for this parameter. With respect to the text data score (Wooden Chair), the query processor checks if the textual metadata identifies the asset as a “wooden chair.” If CHAIR001 is tagged as wooden and a chair, it receives a high score for this parameter. With respect to the spatial data score (Positioned Near a Table in a Dining Room), the query processor evaluates the spatial relationship between the chair and the table, and the scene context (dining room). If CHAIR001 is placed near a table in a dining room, it receives a high score for this parameter. These individual scores are combined to generate a relevance score for CHAIR001 based on how well it matches all the query parameters across different data types. Such functionality is repeated for each of the multiple different digital assets.

Various embodiments then rank each digital asset, of the multiple assets, based at least on the query and the relevancy score for each digital asset. And based at least on the rank of each digital asset, some embodiments cause presentation, at a user device, of an indicator of at least the first digital asset. For example, using the illustration above, the indicator may include the following: CHAIR001 (Rank 1), a thumbnail (an image of the red wooden chair near a table in a dining room), and/or a natural language description (e.g., “Red wooden chair, positioned near a table in a dining room”).

Various embodiments of the present disclosure have various technical effects and benefits relative to existing technologies. For example, various embodiments automate the indexing of digital assets across multiple modalities, which is more accurate and eliminates the need for manual tagging and labeling as is performed by existing technologies. By using AI-generated embeddings and/or metadata extraction, it removes the possibility of human error or inconsistency that occurs when assets are manually labeled. This automation ensures that assets like a chair or table are accurately indexed based on their inherent properties (e.g., shape, material), and not limited to user-supplied tags. As a result, the scope of search queries is significantly expanded, allowing more flexible and complex searches without relying on pre-defined labels.

Additionally, various embodiments enable true multimodal search by integrating multiple data types—e.g., text, visual, and spatial—in a unified system. This allows users to perform queries that require understanding both visual properties and contextual information (e.g., finding wooden chairs in a kitchen), which current single-modality systems struggle to handle. Some embodiments processes geometric shapes, materials, and spatial relationships all at once, allowing it to return highly relevant results for complex queries, without missing important interactions between objects or relying solely on text-based metadata.

Unlike existing technologies that use separate indices for different types of data, various embodiments use a composite index that integrates multiple modalities or sub-indices into a single search operation. This unified approach eliminates the inefficiency of running multiple searches and manually reconciling the results, which not only saves time but also reduces the I/O load on the system. By accessing all relevant data types (e.g., visual, spatial, material) in a single query or I/O operation (e.g., performing a single read of a composite index that includes multiple modalities), various aspects minimize redundant read/write operations and decreases the overall system resource consumption, resulting in faster and more accurate searches.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Digital Asset Retrieval System

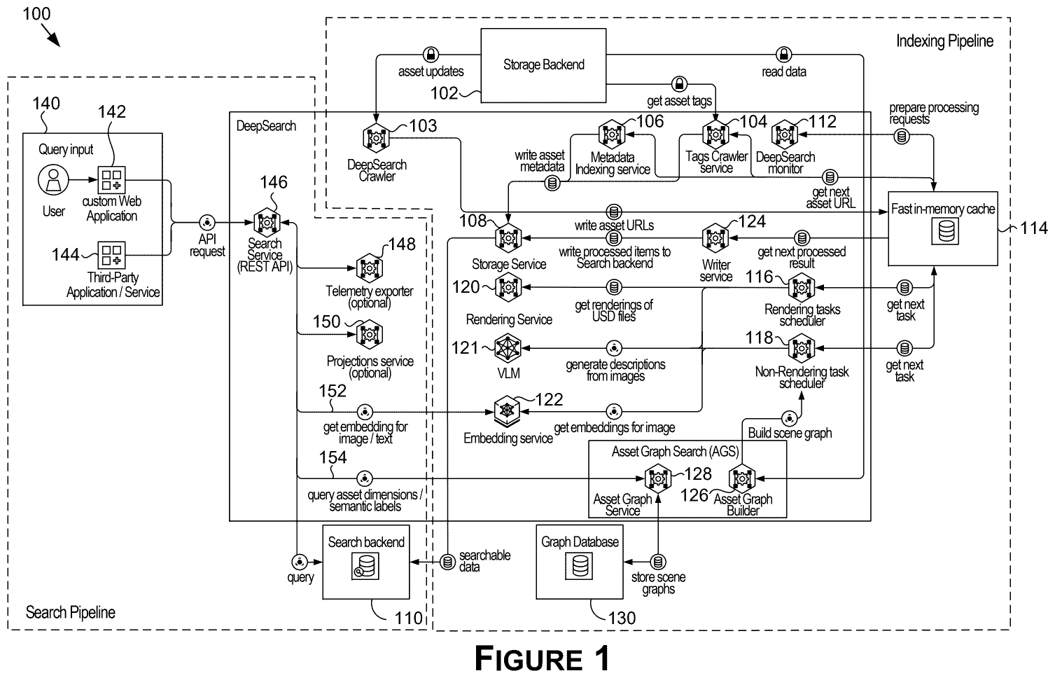

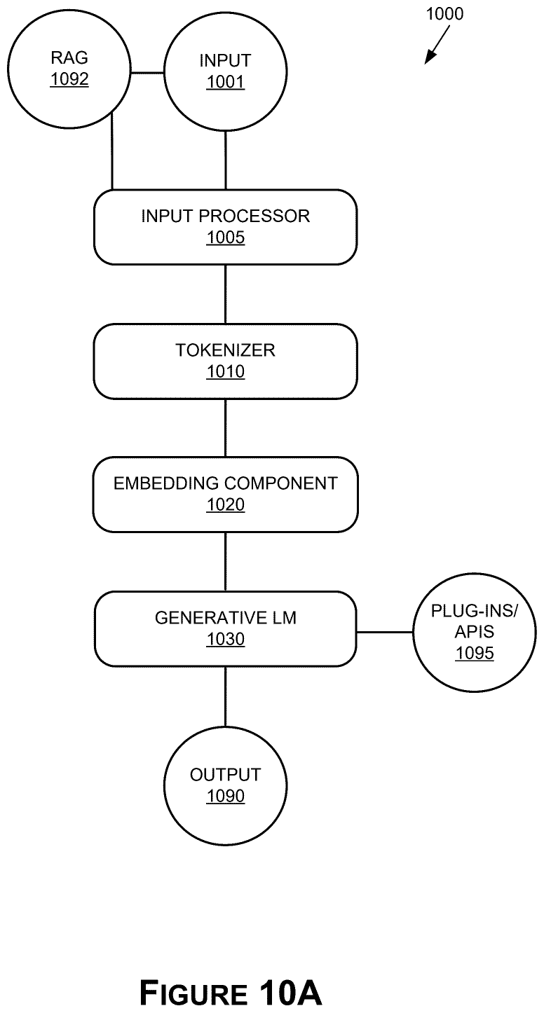

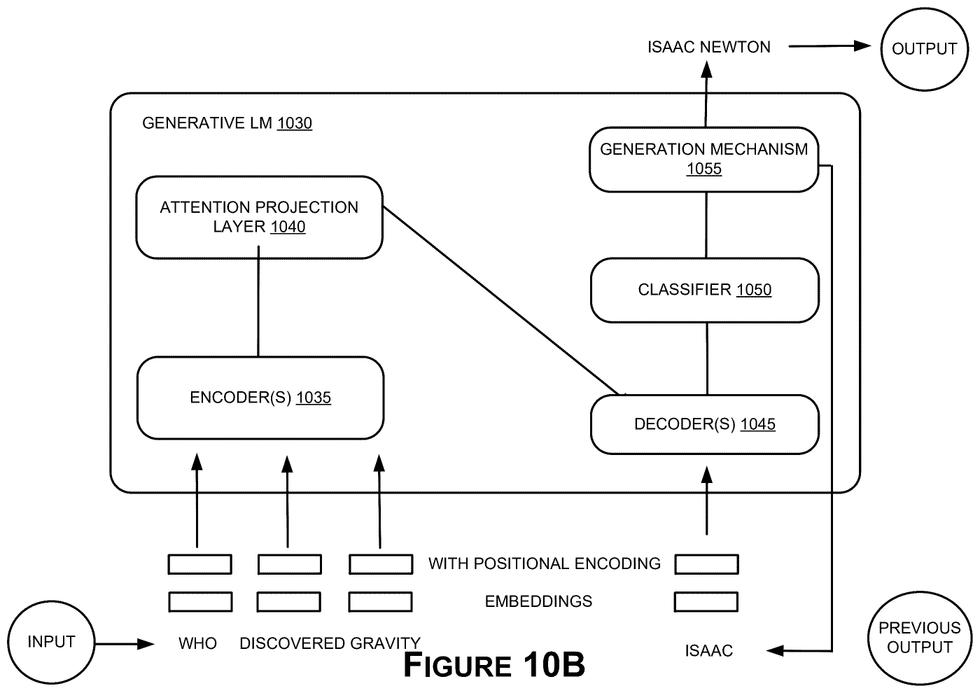

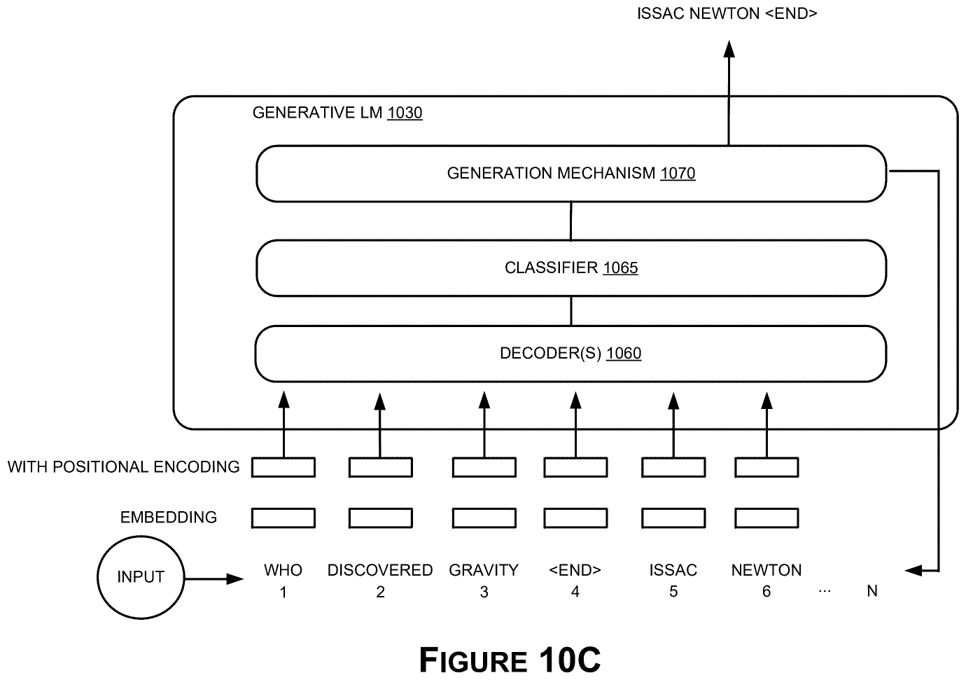

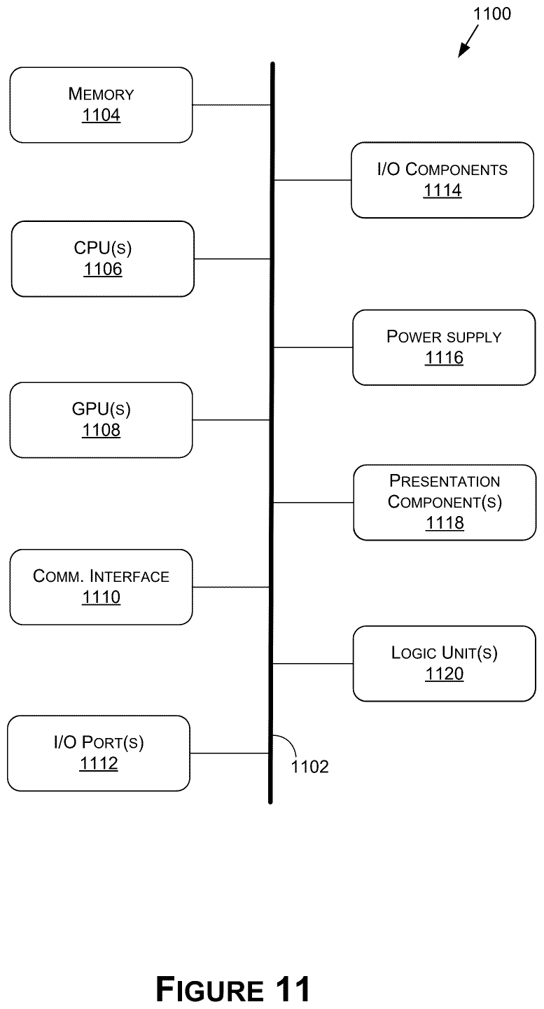

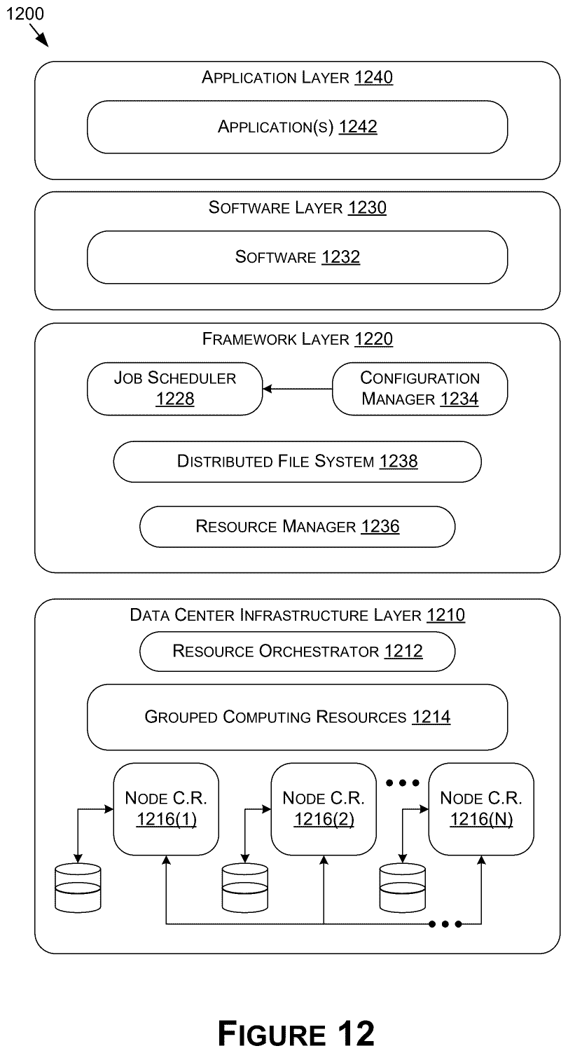

With reference to FIG. 1, FIG. 1 illustrates an example indexing and search pipeline (referred to as “pipeline 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the system and methods described herein (e.g., the VLM 121, the embedding service 122, and/or the rendering service 120) may be implemented using one or more generative language models (e.g., as described in FIGS. 10A-10C), one or more computing devices or components thereof (e.g., as described in FIG. 11), and/or one or more data centers or components thereof (e.g., as described in FIG. 12).

As a high level overview, the pipeline 100 is operable to build a composite index and execute a user query for an asset. At a first time, the storage backend 102 (e.g., AWS S3 or Nucleus) stores and/or updates digital assets. For example, with respect to digital asset creation, a 3D designer uploads a new USD file (which contains a 3D model, textures, and metadata) to the storage backend 102. The storage backend 102 receives the file and stores it in a specified bucket or repository. Each file is given a unique URL or object identifier for later access. In an example illustration of updating, the designer makes updates to the 3D model (e.g., changes the chair's texture or geometry) and re-uploads the file to the same location in the storage backend 102. The storage backend 102 overwrites the existing file or stores it as a new version depending on the configuration. After the storage backend 102 creates or updates digital assets, the digital assets are now available for processing by the indexing system.

The deep search crawler 103 is responsible for scanning and retrieving asset data from the storage backend 102 and ensures that these digital assets are properly processed through the indexing pipeline. It systematically crawls through the stored digital assets (e.g., USD files, 3D models, etc.) to gather relevant data, such as asset metadata, tags, and/or URLs, that will be used in the indexing process. In some embodiments, the deep search crawler 103 passes or writes the gathered asset metadata, URLs, and/or other relevant information to the fast in-memory cache 114 so that downstream components, such as tags crawler 104 (extracts additional metadata or keywords from the assets), metadata indexing service 106 (writes indexed metadata into the search backend 110), or the like can perform their functionality.

The tag crawler service 104 is generally responsible for extracting tags or metadata (e.g., keywords, material properties, or categories) from the digital assets. The input is the raw data or assets from the fast in-memory cache 114 (or storage backend 102) and the output is sending the extracted metadata (“asset metadata) to the storage service 108 and passes asset URLs for further processing. For example, the tag crawler service 104 extracts tags or metadata from digital assets by analyzing the asset's associated data, such as file properties, embedded descriptions, and metadata fields in formats like USD files. It scans through the asset's metadata, identifying relevant keywords (e.g., “chair,” “table”), material properties (e.g., “wood,” “metal”), and categories (e.g., “furniture”). The service may also process visual or textual information embedded in the asset, such as labels or object names, to generate additional tags, which are then indexed and stored for efficient search and retrieval.

The metadata indexing service 106 is generally responsible for indexing the metadata of the digital assets, such as descriptions, labels, or properties, making it ready for search. The metadata indexing service 106 passes the indexed metadata to the storage service 108, which then writes indexed metadata into the search backend 110 to be searchable.

The deep search monitor 112 is generally responsible for overseeing the entire indexing process, ensuring digital assets are processed correctly. The deep search monitor 112 coordinates processing of updates and new assets. The deep search monitor 112 take as input a stream of updates and distributes it across different plugin-specific processing queues. The fast in-memory cache 114 manages a queue of tasks, storing information about which digital assets need to be processed and which have already been processed. It provides the next task for the processing components, like the rendering tasks scheduler 116 or non-rendering tasks scheduler 118.

The rendering tasks scheduler 116 is generally responsible for managing the rendering of visual assets, such as USD files, into images or visual representations. It receives the next task (such as rendering a 3D model) from the fast in-memory cache 114 and passes USD files to the rendering service 120 for further processing. For example, the rendering tasks scheduler 116 receives a new task from the in-memory cache 114 to render a 3D model of a wooden chair stored as a USD file. It retrieves the task details, locates the USD file in the storage backend (e.g., AWS S3), and passes the file to the rendering service 120, which processes the 3D model into a visual representation, such as a 2D image or thumbnail, for further use in search indexing or user previews.

The rendering service (e.g., Kit-Based) 120 processes and converts USD files into visual outputs (like images, thumbnails, or renderings). For example, the rendering service 120 processes and converts USD files by utilizing a rendering engine that interprets the 3D scene data, including geometry, textures, materials, lighting, and camera settings, embedded in the USD file. When a USD file is passed to the service, it reads the file's scene graph, which defines the spatial relationships between objects, and applies the defined materials and textures. The rendering engine then simulates lighting and shading based on the scene's parameters and generates a visual output, such as an image or thumbnail. The result is a rendered 2D representation of the 3D asset, which can be used for display in user interfaces or further processing in search and indexing pipelines.

In some embodiments, the rendering service 120 uses a combination of models and functions, including ray tracing algorithms, path tracing for realistic lighting simulations, rasterization for real-time rendering, and physically-based rendering (PBR) models to simulate materials accurately. In some embodiments, the rendering service 120 leverages illumination models (e.g., Phong or Blinn-Phong) to determine how light interacts with surfaces, and global illumination techniques to simulate light bouncing across objects. Advanced rendering services may also incorporate machine learning models to enhance image quality through denoising or optimize rendering speeds using neural networks. For GPU-accelerated tasks, frameworks like CUDA or OptiX may be used to offload heavy computations, while functions such as culling and level of detail (LOD) management ensure efficient processing of complex scenes by rendering only visible elements.

The embedding service 122 generates embeddings (vector representations, such as multimodal embeddings) from images or text descriptions. These embeddings are used for efficient search and retrieval. For instance, the embedding service 122 receives rendered images and/or metadata from the rendering service 120 and/or the VLM 121 and generates corresponding embeddings. The generated embeddings are stored and indexed in the fast in-memory cache 114 to make assets searchable when the writer service 124 writes the embeddings to the storage service 108, which then passes the embeddings to the search backend 110. In an illustrative example, the embedding service 122 generates embeddings by processing images or text descriptions through deep learning models, such as Vision-Language Models (VLMs) 121 (either NIM or API call) like CLIP. For an image, in some embodiments, the service 122 uses a convolutional neural network (CNN) or transformer-based model to extract visual features, while for text, a language model (e.g., a transformer) is used to encode the textual description. These features are then projected into a shared embedding space, where the image and text data are mapped to vectors that capture their semantic meaning. The goal is to ensure that images and their corresponding textual descriptions produce similar vectors, enabling efficient multimodal retrieval.

The non-rendering tasks scheduler 118 handles tasks that do not require rendering, such as asset metadata extraction or graph-building tasks. In some embodiments, it receives tasks from the fast in-memory cache 114, which has been formulated by the deep search monitor 112 that do not involve rendering. The scheduler 118 passes tasks from the cache 114 and passes them to the VLM 121 and the results from the VLM are written back to the cache 114. In an example illustration, when a task is received (e.g., extracting metadata from a USD file or building a graph representing object relationships), the scheduler 118 assigns it to the appropriate service.

The writer service 124 passes processed metadata, URLs, and other information generated by the rendering service 120, VLM 121, the embedding service 122, and/or the asset graph builder 126 (which has been stored to the cache 114) to the storage service 108, which then writes such information to the search backend 110. For instance, it retrieves the “renderings of USD files,” (generated by the rendering service 120), the “descriptions from images” (generated by VLM 121), the “embeddings for image” (generated by the embedding service 122), and the “scene graph” (generated by the asset graph builder 126) from the fast in-memory cache 114, which gets written to the search backend 110 for later query processing. After assets are processed (e.g., after metadata extraction or rendering tasks), the writer service 124 takes the output-such as asset identifiers, metadata tags, URLs of rendered images, embedding vectors, or asset graphs-and writes this information into the appropriate index or database. This ensures that all the processed data is correctly stored and indexed, making it searchable or retrievable during query operations. For example, after a USD file is rendered into a thumbnail, the Writer Service 124 would log the thumbnail URL and relevant metadata to the search index for future queries.

The asset graph builder 126 builds graph data structures from asset relationships and spatial information (e.g., connections between objects in a 3D scene), as described in more detail below. It receives input scene data from the storage backend 102 other services. At the output, it builds and sends graph data to the asset graph service 128 for storage at the graph database 130 and/or sends the graph data to the non-rendering task scheduler 118 to be stored to the fast in-memory cache 114. The asset graph service (AGS) 128 manages the graph-based data structures generated by the asset graph builder 126. The AGS 128 stores these graphs in the Graph Database 130 (e.g., gateway Neo4j) and makes them queryable. The graph database 130 stores the graph data that captures relationships between objects, metadata, and/or spatial information. It receives graph data from the asset graph service 128 and provides graph data for query processing when needed.

Once the indexing pipeline is complete, the query processing/search pipeline begins by processing the query input 140. The custom web application 142 is a user interface or platform where a generic user interacts with the system. It could be a web-based interface that allows users to submit search queries. The generic third-party application/service 144 refers to an external or third-party service that integrates with the pipeline 100 system through APIs, allowing it to query the search system. Both the custom web application 142 and third-party services 144 serve as entry points for users or systems to submit queries. The query 140 is passed to the search service (REST API) 146 for processing. Search service (REST API) 146 acts as the central query handler. It receives queries from users (via web apps or third-party services) and coordinates the retrieval of relevant data by communicating with other components of the system. The service 146 passes the query to the appropriate downstream services such as the search backend 110 for querying previously indexed data, telemetry exporter 148 or projections service 150 depending on the query needs.

Telemetry Exporter 148 collects performance data (e.g., how fast queries are processed, system load) and exports it for analysis and monitoring. In some embodiments, the Telemetry Exporter represents NVIDIA's DeepSearch telemetry exporter, which is part of their broader telemetry infrastructure integrated within the DOCA (Data Center Infrastructure on a Chip Architecture) Telemetry Service. This exporter provides capabilities for collecting, managing, and exporting telemetry data from various sources, such as GPUs and DPUs (Data Processing Units), within the NVIDIA ecosystem. The exporter facilitates the transfer of telemetry data (performance metrics, events, counters, etc.) from applications or hardware into a centralized telemetry service. It supports various data formats and transmission protocols, like NetFlow, Fluent Bit, and Prometheus, to aggregate and forward data to collectors or external systems for monitoring and analysis.

In some embodiments, the Projections Service 150 projects between dimensionalities (e.g., from 2D to 3D). In some embodiments, the Projections Service 150 operates on embeddings. For example, it allows to project highly dimensional (e.g., 500-1000) text or image vectors into a 2D or 3D space in order to visualize it to the user. The assumption is that such projection maintains as much variance of the original dimensionality as possible, as a result clustering similar assets together in the new reduced dimensionality. This allows users to browse the vector space like a 2D map/3D space. In some embodiments, the Projections Service 150 handles requests that involve asset-specific projections or customized views. If the query requires generating special projections of the assets or customized data views, this service 150 would take part in the processing. For example, a user can submit a query like, “Show me all views of a red wooden chair from the top perspective”. The Projections Service 150 receives the query for the specific asset (red wooden chair) and the required view (from the top). The service 150 dynamically generates a custom projection of the 3D model from the requested angle (e.g., top-down view of the chair). The service 150 could also take into account specific lighting, camera angles, or any transformations applied to the asset to create the desired 2D render of the 3D object. The Projections Service 150 would then send this customized 2D image or real-time view back to the user as part of the search results. This would allow the user to view the asset from the specific perspective they requested without manually interacting with the 3D model.

The search backend 110 (e.g., OpenSearch) serves as the core search engine. It processes user queries by retrieving data that has been previously indexed, such as metadata, embeddings, and asset information. The input is the search query from the search service 146 (REST API). For the output, it retrieves searchable data (metadata, embeddings, and graph information) and sends it back to the user via the search service 116. In some embodiments, the search backend 110 stores indices for the various sub-indices (e.g., text, visual, spatial data) linked to a digital asset. When a query is received, the search backend 110 efficiently processes it, retrieving relevant assets by matching keywords, metadata, or embeddings. Its flexibility allows the system to rank and filter results, enabling multi-criteria search (like querying both visual and spatial data) in real time.

In some embodiments, the graph database 130 receives query requests from the search backend 110 (if the query involves retrieving graph data, such as spatial or hierarchical relationships between assets). At process 152-Get Embedding for Image/Text-if the user query involves a search for images or textual descriptions, this component retrieves embeddings that represent those assets. The embedding is a vector representation of the asset that captures its semantic meaning. The Get Embedding for Image/Text process 152 works by retrieving vector embeddings that have been pre-computed for both images and text descriptions using a vision-language model (VLM) like CLIP. When a user submits a query (e.g., a text description like “red wooden chair” or an image of a chair), some embodiments first encode the query using the same embedding model that was used to generate embeddings (via the embedding service 122) for the indexing pipeline. For text queries, a language encoder converts the text into a vector, while for image queries, a vision encoder processes the image into a vector. These embeddings represent the semantic meaning of the input (e.g., color, material, object type). The Get Embedding for Image/Text component 152 then retrieves precomputed embeddings from the search backend 110 (or embedding database) and compares them with the query embedding in the same vector space, enabling similarity search. Assets with embeddings closest to the query vector are returned as results. With respect to the similarity search, for example, some embodiments compute a distance metric such as cosine similarity or Euclidean distance between the two embeddings. These metrics calculate the angle or distance between the query vector and the stored vectors. If two vectors are close together (i.e., the distance or angle between them is small), it indicates that the assets are semantically similar. The system ranks all assets based on their similarity scores, and those with the highest similarity (or smallest distance) to the query embedding are returned as the most relevant results. This allows the system to efficiently retrieve assets that match the user's search intent, whether the query is based on text or images.

The query asset dimensions/semantic labels process 154 queries the AGS 128 for spatial data such as asset dimensions (e.g., size, scale,) or semantic labels (e.g., tags or categories assigned to assets). For instance, if a user is looking for objects of a specific size or tagged with certain keywords via the user query 140, this component handles that query by returning spatial data from the asset graph service 128, which fetches the graph data structures from the graph database 130.

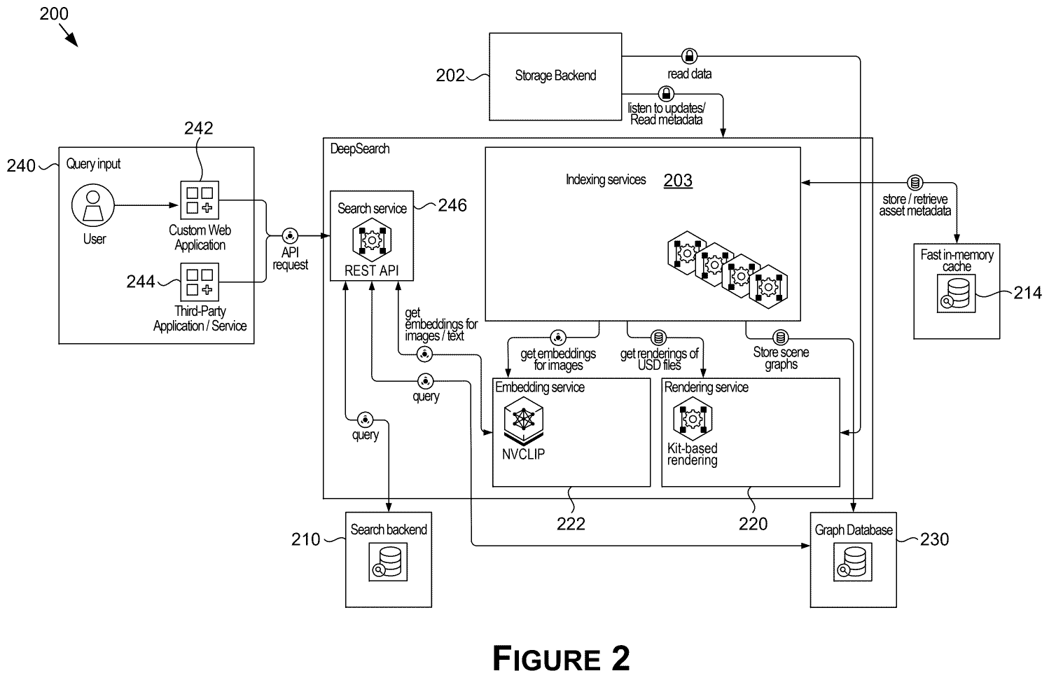

FIG. 2 illustrates an example search pipeline 200, according to some embodiments. At a first time, the query input 240 is received by the Search Service 246. In some embodiments, the query input 240 is issued from a Custom Web Application 242. This component corresponds to a web interface through which the user interacts with the system to submit queries. Alternatively, in some embodiments, the query input is issued from a Third-Party Application/Service 244. This is an external or third-party service that interacts with the system via API requests. The query input 240 captures the user's search request (e.g., searching for a specific 3D model or asset). The output is an API request to the Search Service (REST API) 246 for processing.

The Search Service (REST API) 246 is responsible for handling incoming API requests and coordinating the search across various components of the pipeline 200. It distributes the query to other components like the Search Backend 210 (OpenSearch), the graph database 230, Embedding Service 222, and/or the Rendering Service 220 for further processing and responsively receives corresponding search results. For example, when a user submits a query 240, such as “3D models of red chairs,” the Search Service 246 receives the API request and coordinates the search. It first sends the query 240 to the Search Backend 210 to retrieve any indexed metadata related to red chairs. If the search involves comparing visual features, the Search Service 246 forwards the query to the Embedding Service 222, which retrieves the relevant embeddings for both the text description “red chair” and stored 3D model embeddings (e.g., those embeddings stored to the fast in-memory cache 214). The results from these components are then aggregated and sent back to the user via the Search Service 246, which acts as the coordinator between all the services involved in processing the query.

The Search Backend (e.g., OpenSearch) 210 is the core search engine that stores searchable data such as metadata, embeddings, and/or asset-related information. It is queried directly by the Search Service 246. The Search Backend 210 returns the search results (e.g., asset metadata, embeddings, or graph data) to the Search Service 246 to be delivered back to a user device of the user.

The Embedding Service 222 (e.g., NVCLIP) generates and stores embeddings (vector representations) for assets, enabling efficient retrieval based on text or image queries. NVCLIP refers to a vision-language model that can process both text and images into a shared embedding space. It receives a request from the Search Service 246 to retrieve or generate embeddings for images or text. The embedding service 222 sends the embeddings back to the Search Service 246, allowing for similarity-based search.

When a digital asset (e.g., a 3D model or image) is retrieved from the Storage Backend 202 and processed by services such as the Rendering Service 220, it generates visual data like thumbnails or previews. Once the visual or textual data is generated and processed, the Embedding Service 222 encodes these data into embeddings-numeric vectors that represent the asset in a way that allows for similarity search and efficient retrieval. These embeddings are passed back through the Indexing Services 203 and stored in the Search Backend (OpenSearch) 210, where they can be queried later during the search process, such as via query 240.

Fast In-Memory Cache 214 (e.g., REDIS) is used as a fast in-memory cache for storing and managing search tasks, indices from the indexing services 203, asset metadata, and/or processing tasks. The Graph Database 230 (e.g. Neo4j) stores and manages the graph-based data that represents relationships between digital assets, such as spatial relationships, dependencies, or hierarchical structures. The Rendering Service 220 generates visual representations (e.g., thumbnails or rendered images) from USD files or 3D models. It receives a USD file or 3D model to be rendered into an image or visual output. At the output, it sends the rendered images to the Embedding Service 222 for embedding generation and subsequent storage in the Search Backend.

As illustrated in FIG. 2, the Rendering Service 220 includes kit-based rendering functionality. Developers can select and configure various rendering modules, such as ray tracing, path tracing, or real-time rendering, depending on the use case and performance needs. Kit-based rendering supports the integration of custom shaders, materials, and/or physics simulations, making it ideal for highly specific workflows like architectural visualization, digital twins, and virtual production. In an illustrative example, when a USD file is passed through the kit-based rendering service 220, it uses this framework to generate thumbnails or high-quality previews of the scene, such as traffic cones or furniture in a 3D room. This flexible approach allows developers to select the appropriate rendering pipeline based on the desired output (thumbnails, real-time previews, or photorealistic renders).

The Indexing Services 203 are responsible for preparing, indexing, and/or managing asset data, including metadata extraction, graph building, and embedding generation. For example, as described with respect to FIG. 1, a Search Crawler crawls and retrieves asset data from storage, a Metadata Indexing Service extracts and indexes metadata for each asset, A Tags Crawler Service extracts tags and keywords from the assets, a Rendering Tasks Scheduler manages the scheduling of rendering tasks, a Non-Rendering Tasks Scheduler manages other tasks like metadata processing or graph building, an Asset Graph Service (AGS) stores graph data for assets, an Asset Graph Builder constructs graph structures from asset relationships. In other words, the input to the indexing services 203 is the receipt of asset data (such as USD files) from the Storage Backend 202. The output is indexed metadata, generated embeddings, and/or stored graph data in the Search Backend 210 and Graph Database 230 for later querying. The Storage Backend 202 (e.g., AWS S3, Enterprise Nucleus) is the source of raw digital assets such as USD files or 3D models.

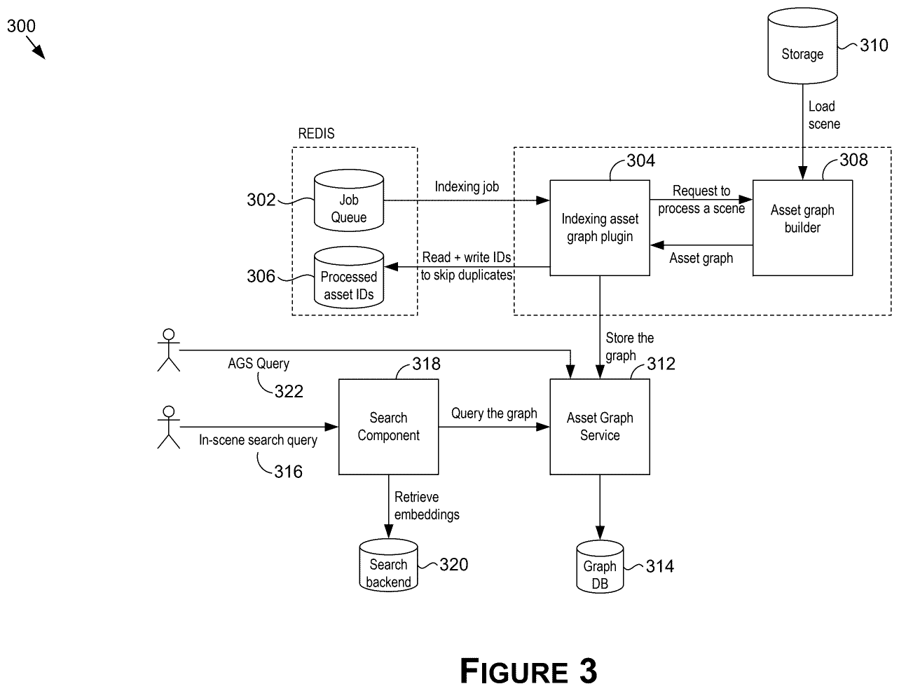

FIG. 3 illustrates an example pipeline 300 that processes and indexes digital assets into graph data structures, storing them for querying and retrieval through both general and scene-specific search queries, according to some embodiments. The job queue 302 holds or stores indexing tasks (scenes or assets that need to be processed) and forwards them as indexing jobs to the indexing asset graph plugin 304. In other words, the job queue 302 receives tasks to process and index digital assets. Responsively, the indexing asset graph plugin 304 sends a request to the asset graph builder 308 to process the scene and generate an asset graph by using a loaded scene as input from storage 310. For example, the asset graph builder 308 starts by loading the scene data (e.g., a 3D model or environment) from storage 310 (such as AWS S3 or Nucleus). This scene could be a USD file that includes multiple objects with properties like geometry, materials, and textures. The asset graph builder 308 decomposes the loaded scene into individual elements or “prims” (primitives), which represent the objects within the scene (e.g., tables, chairs, lights). At least one (e.g., each) prim may have specific attributes, such as its size, position, material, and relationship to other objects. The builder 308 organizes these elements into a graph data structure, where nodes represent individual objects or entities within the scene (e.g., a chair or a table) and edges represent the relationships between objects (e.g., a chair is placed next to a table, or a lamp is above the table). The graph data structure reflects both hierarchical relationships (e.g., the lamp is a child of the table in the scene hierarchy) and spatial relationships (e.g., the chair is 1 meter away from the table). These relationships are useful for understanding the scene's structure and positioning of objects.

After processing the scene into an asset graph, the asset graph builder 308 sends the constructed graph to the indexing asset graph plugin 304, which forwards the graph to the asset graph service 312 for storage in the graph database 314 (Graph DB). This graph can later be queried to retrieve information about the spatial, hierarchical, and material properties of the objects in the scene. Simultaneously or in parallel, the indexing asset graph plugin 304 tracks already-processed digital assets (e.g., via logging) to prevent duplicates. The inputs are asset IDs from successfully indexed assets derived from the indexing asset graph plugin 304. For the output, the indexing asset graph plugin 304 reads from this to ensure that duplicate assets are skipped in future jobs.

At search or query time, a user can submit an Asset Graph Service (AGS) query 322, which gets forwarded to the asset graph service 312, which responsively retrieves, from the graph database 314, one or more relevant graph data structures dependent on the AGS query 322. Processing the AGS query 322 using the asset graph service 312 involves looking up relationships, properties, or metadata about assets stored in the Graph DB 314, such as relationships between digital assets. These operate on a higher level of abstraction relative to the in-scene search query 316, such as general asset details from the asset graph service 312, which could be queried by users or external systems needing information about stored assets. For example, the ASG query 322 may be “all chairs within 2 meters of any table in the current scene(s).” The AGS query 322 is sent to the asset graph service 312, to search for relationships between chairs and tables based on spatial proximity. The asset graph service 312 queries the graph database 314 (which contains the asset graph) to locate nodes (chairs and tables) and analyze the edges (which represent the spatial relationships). The system looks for any chair node that has an edge (spatial relationship) to a table node where the distance is less than or equal to 2 meters. The result would be a list of chairs in the scene(s) that meet this condition, possibly returned with details such as asset IDs or positions.

The “in-scene search query” 316 focuses on searching within a specific scene, typically based on asset properties like color, type, material, and/or metadata. It is more localized to the current scene and its content, without necessarily leveraging complex graph relationships. This query 316 typically focuses on retrieving assets based on simple properties (e.g., object type, color, material) in the current scene. The search component 318 receives the in-scene search query 316, retrieves one or more relevant embeddings from the search backend 320 and/or queries the asset graph service 312 to derive the appropriate graph data structures dependent on the query.

For example, the in-scene search query 316 may be “red chairs for this living room scene.” The search backend 318 stores precomputed embeddings (vector representations, such as multimodal embeddings) of the digital assets in the scene. These embeddings were generated during the indexing process by an embedding service and contain detailed information about each asset's visual, textual, and material properties. Using the illustration above, the search component 318 sends a request to the search backend 320 to retrieve the embeddings for all assets in the current scene, focusing specifically on the ones that are chairs. The embeddings contain encoded information about various attributes of the assets, such as their color (e.g., red), type (e.g., chair), and other visual/textual details.

Once the search component 318 retrieves the embeddings for one or more (e.g., one, some, or all) chairs in the scene, it applies the query conditions (i.e., “red” to filter out the chairs that do not match the color condition. The color information is encoded within the embeddings, allowing the search component 318 to compute similarity scores or directly filter for assets that have the “red” color attribute. After filtering the embeddings, the search component 318 identifies the red chairs that exist in the living room scene. The system returns the relevant results (e.g., asset IDs, positions, and/or visual representations) to the user device, showing all red chairs in the scene.

In an example illustration of how the asset graph service 312 works when an in-scene search query 316 is issued, the query 316 may be “all red chairs in this living room scene.” The search component 318 responsively queries the asset graph service 312 to identify all objects in the scene categorized as chairs. The asset graph service 312analyzes the scene's graph structure to find all chair nodes and retrieves their spatial relationships (e.g., where each chair is positioned in the living room). Simultaneously, the search component 318 retrieves the embeddings for each chair from the Search Backend, which contain visual information like the color of each chair. The search component 318 combines the graph data (spatial relationships) with the embedding information (color attributes) to filter out any chairs that are not red. The graph data helps the search component 318 to understand the positions of the chairs, while the embeddings help refine the query based on visual attributes. The result is a list of red chairs in the living room scene, including their positions within the scene. The user receives the filtered results based on both the scene's graph structure and the embeddings.

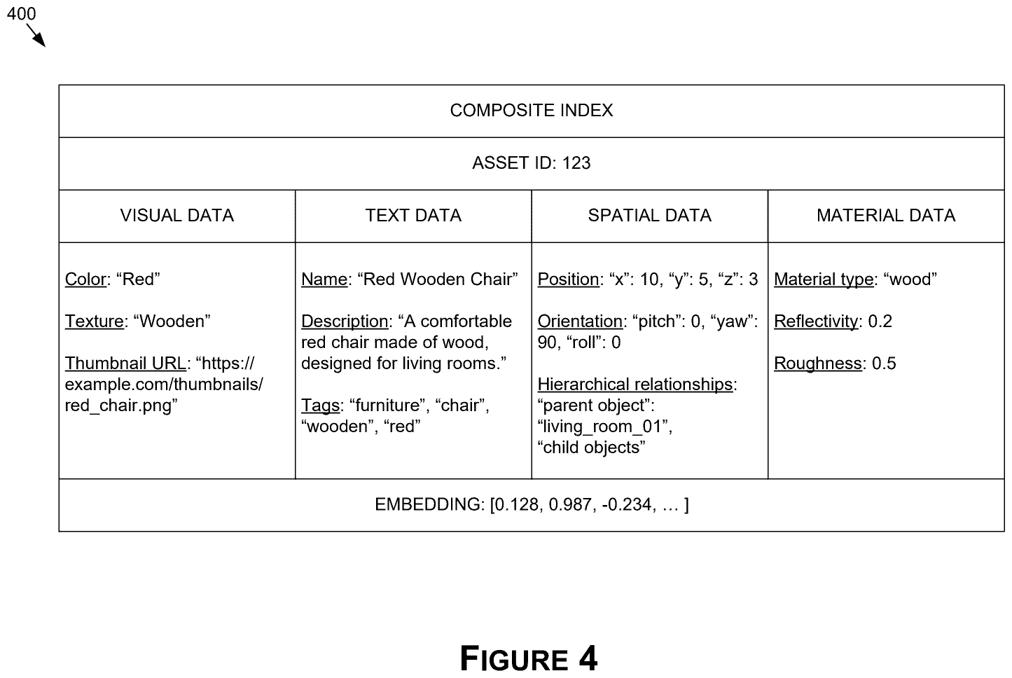

FIG. 4 is a schematic diagram of an example composite index 400, according to some embodiments. In some embodiments, the composite index 400 represents what is built by the indexing services 203 of FIG. 2 or how the indexing pipeline of FIG. 1 populates a composite index. A composite index is a data structure that associates multiple types or modalities of data (e.g., visual, text, spatial, material) about a digital asset under a single identifier (Asset ID). Asset ID (asset_id_123) is the unique identifier for the digital asset (in this case, a red wooden chair). The “Visual Data” column stores attributes related to the visual appearance of the digital asset. The “color” attribute represents the primary color of the asset. The “texture” attribute describes the surface material (wooden). The “thumbnail_url” attribute refers to the URL to the thumbnail image of the asset. In some embodiments, a composite index includes or references multiple digital assets, instead of just one.

The “Text Data” column stores textual descriptions, names, and tags that can be used for text-based search. The “name” attribute is a short name or title for the asset. The “description” attribute is a more detailed description of the asset. The “tags” attribute refers to a list of keywords that describe the asset.

The “Spatial Data” column contains information about the asset's position, orientation, and relationships to other objects in the scene. The “position” attribute refers to the coordinates of the asset in the 3D space. The “orientation” refers to the orientation of the asset in terms of pitch, yaw, and roll. The “hierarchical_relationships” attribute refers to information about the parent or child objects in the scene (e.g., the chair is part of a living room scene).

The “Material Data” column describes the material properties of the object/asset. The “material_type” attribute refers to the type of material (e.g., wood, metal). The “reflectivity” attribute describes how reflective the material is (a number between 0 and 1). The “roughness” attribute refers to how rough the material appears. The “Embedding” is a vector representation of the asset generated by the embedding service. This vector is used to compute similarity between assets, enabling searches like “find similar chairs.”

When a query is made (e.g., “red chairs for this living room”), the system can: query the “text data” to retrieve assets that match the description or tags (“red” and “chair”), query the “visual data” for images or thumbnails to visually inspect the asset, query the “spatial data” to ensure the chair is within the correct scene or positioned in relation to other objects (e.g., in the living room), and/or query the embedding to find chairs that are visually or textually similar (e.g., based on the embedding vector). The composite index 300 allows the system to organize multiple types of information (text, visual, spatial, material) under a single asset ID. It enables the system to efficiently retrieve relevant data for queries and perform searches based on any combination of these data types (e.g., finding assets by description, position in space, or similarity in appearance).

Below is an example of how the composite index 400 is represented programmatically using a dictionary (in Python-style pseudocode) or JSON-like structure:

```
composite_index = {
  “asset_id_123”: {
    “visual_data”: {
      “color”: “red”,
      “texture”: “wooden”,
      “thumbnail_url”: “https://example.com/thumbnails/red_chair.png”
    },
    “text_data”: {
      “name”: “Red Wooden Chair”,
      “description”: “A comfortable red chair made of wood, designed for living rooms.”,
      “tags”: [“furniture”, “chair”, “wooden”, “red”]
    },
    “spatial_data”: {
      “position”: {“x”: 10, “y”: 5, “z”: 3},
      “orientation”: {“pitch”: 0, “yaw”: 90, “roll”: 0},
      “hierarchical_relationships”: {
        “parent_object”: “living_room_01”,
        “child_objects”: [ ]
      }
    },
    “material_data”: {
      “material_type”: “wood”,
      “reflectivity”: 0.2,
      “roughness”: 0.5
    },
    “embedding”: [
      0.128, 0.987, −0.234, ... # Vector representation for similarity search
    ]
  }
}
```

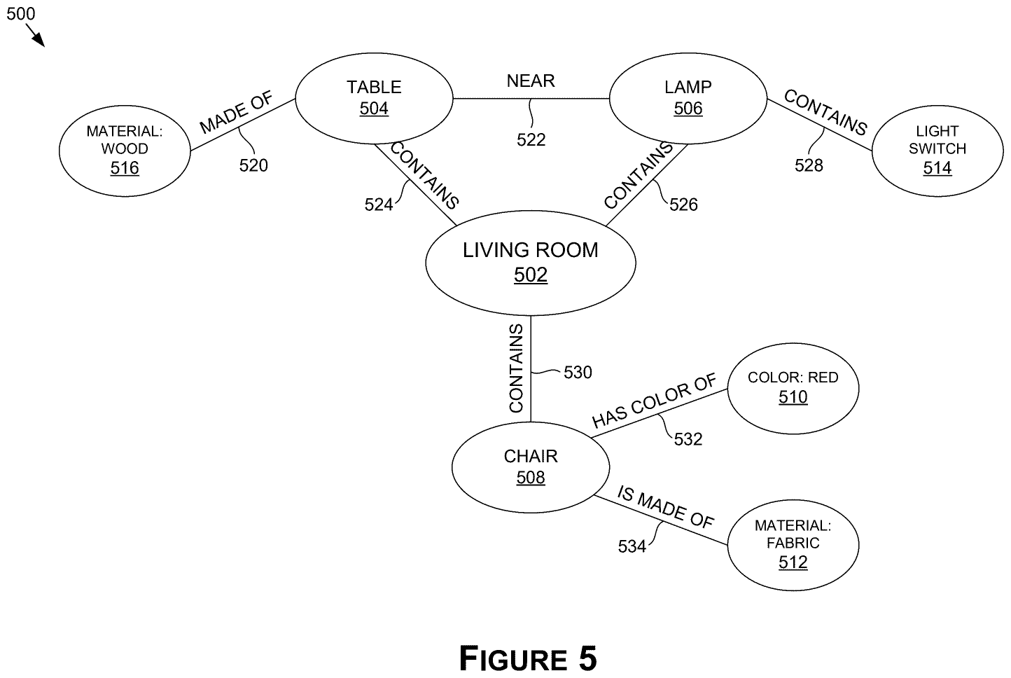

FIG. 5 is a schematic diagram illustrating an example graph data structure 500 (e.g., an asset graph) that contains graph data, according to some embodiments. In some embodiments, the graph data structure 500 represents a Directed Acyclic Graph (DAG), specifically a hierarchical DAG with directional edges that represent relationships like “contains”, and “made of”. In some embodiments, the graph data structure 500 represents what is built by the asset graph builder 308 of FIG. 3, and/or the asset graph builder 126 of FIG. 1.

The graph data structure 500 contains multiple nodes 502, 504, 506, 508, 510, 512, 514, and 516, and multiple edges 520, 522, 524, 526, 528, 530, 532, and 534 that connect the nodes. The graph data structure 500 specifically represents a 3D scene of a living room containing a red chair, a wooden table, and a lamp. In this graph data structure, nodes represent different assets and properties (objects, materials, colors), while edges represent the relationships between these assets (spatial, hierarchical, material). The graph structure 500 enables efficient querying of the scene by navigating through these relationships, allowing searches based on attributes like spatial proximity, object type, material, or other connections between the assets. In other words, this graph data structure 500 represents relationships between different digital assets (e.g., 3D models, objects in a scene) based on various characteristics like spatial positioning, hierarchy, and dependencies between objects in a 3D scene or environment.

The Living Room node 502 represents the scene itself, containing the other objects —i.e., the Chair Node 508, the Table node 504, and the Lamp node 506. The Chair node 508 represents a chair, which is a child of the living room node 502. The Color: Red node 510 represents the visual property (color) of the chair. The Material: Fabric node 534 represents the material used in the chair. The Table node 504 represents a wooden table. The Material: Wood node 516 represents the material used for the table. The Lamp node 506 represents a lamp, which has an interaction with or contains a light switch. The Light Switch node 514 represents the object that controls the lamp.

With respect to the edges, there are hierarchical edges, spatial edges, dependency edges, and material edges. The hierarchical edges include edges 524, 526, and 530, which connect the Living Room node 502 to the Chair node 508, Table node 504, and Lamp node 506, indicating that these objects are part of the scene. The spatial edge 522 is an edge between the Lamp node 506 and the Table node 504, which represents their spatial relationship (e.g., “Lamp near Table”). The dependency edge 528 is an edge between the Lamp node 506 and the Light Switch node 514, which represents a dependency (the light switch controls the lamp). The material edge 520 is an edge from the Wood node 516 to the Table node 504, representing that the table is made from wood and/or has a wood-like material property or appearance.

A query like “red chairs in the living room” would traverse the graph data structure 500, starting from the Living Room node 502, looking for Chair nodes that have an edge to a Color node with the value Red, such as node 510. A query like “objects near the table” would traverse the graph data structure 500, starting at the Table node 504, and follow the spatial edges to find any connected objects within the scene (e.g., Lamp node 506).

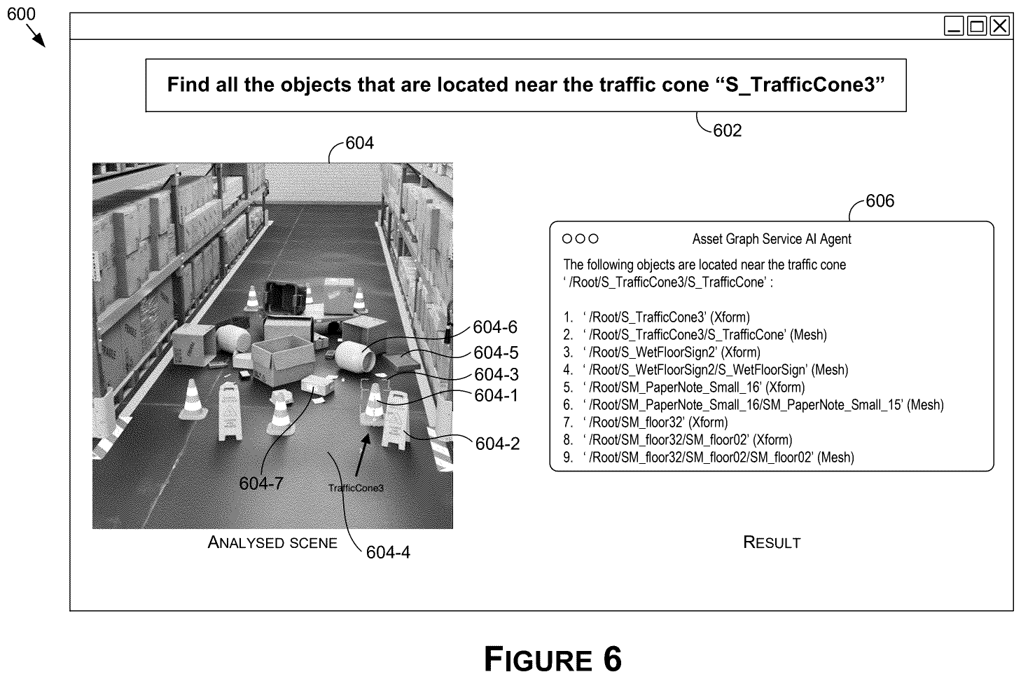

FIG. 6 is a screenshot of an example user interface page 600 illustrating execution of a proximity search, according to some embodiments. At a first time a user uploads a digital asset 604, which is an image of a scene that includes various elements or objects. At a second time the user issues a query 602 into a text field-“Find all objects that are located near the traffic cone ‘S_TrafficCon3.’” The query 602 represents a proximity search, such as, for example, the “in-scene search query” 316 of FIG. 3. In response to receiving an indication that the user has issued the query 602 and uploaded the digital asset 604, the asset graph service 312 of FIG. 3 locates the corresponding graph data structure within the graph database 314 and/or the search component 318 retrieves corresponding embeddings from the search backend 320.

In this query 602, spatial relationships are important, meaning the system needs to understand the relative positions of objects in the scene that the digital asset 604 represents, particularly in relation to the specified cone 604-2 (S_TrafficCone3). This is where the asset graph service 312 (AGS) and asset graph come into play. The search component 318 queries the AGS 312 for spatial relationships within the scene. The AGS 312 manages a graph where nodes represent objects (like cones, boxes, signs), and edges represent relationships (such as spatial proximity, hierarchical dependencies, etc.).

The search component 318 sends a request to the AGS 312 to find all objects that have an edge to S_TrafficCone3 labeled “near” or similar spatial relationships. The AGS 312 searches through the graph to identify all objects that are spatially connected to the S_TrafficCone3 node via a proximity edge (representing objects that are “near”). The AGS 312 returns a list of nearby objects (nodes connected via spatial edges) to the search component 318. These include objects, such as the floor sign 604-2, paper note 604-3, paper note 604-4, box 604-5, barrel 604-6, and box 604-7 positioned close to S_TrafficCone3.

After (or before) identifying the relevant objects that are spatially near S_TrafficCone3 604-1 from the AGS 312, the search component 318 further processes the query 602 by retrieving the embeddings of these objects from the search backend 320. The search component 318 sends a request to the search backend 320 to retrieve the embeddings for each of the objects identified from the graph query (e.g., cones, paper notes, boxes, barrels). The search backend 320 looks up the embeddings for these objects, which were generated during the indexing phase by the Embedding Service. These embeddings might encode information such as the color, shape, and material of the objects. The search component 318 retrieves the embeddings and processes them to filter or rank the objects if the user query includes additional conditions (such as filtering objects by material or other attributes).

After the search component 318 completes both the graph query and the embedding retrieval, it combines the spatial data from the AGS 312 (showing which objects are near S_TrafficCone3 604-1) with the embeddings from the search backend 320 to refine the results further if needed. The system returns the “Result” 606, which is a list of objects near S_TrafficCone3 604-1 (i.e., the floor sign 604-2, paper note 604-3, paper note 604-4, box 604-5, barrel 604-6, and box 604-7) to the user device. The returned data includes the spatial relationships (proximity to S_TrafficCone3) and other asset properties derived from the embeddings (e.g., color, material, etc.).

In some embodiments the “Results” 606 alternatively or additionally is an output image that represents the digital asset 604, except that each of the objects 604-1, 604-2, 604-3, 604-4, 604-5, 604-6, and 604-7 are highlighted, which indicates that these are the objects that are located near the traffic cone 604-1 according to the query 602. For example, some embodiments superimpose pixel data (e.g., a certain color) or other data (e.g., a bounding box) over these objects to indicate that they are all objects near the target traffic cone 604-1.

It is understood that the query 602 is representative only and that embodiments can handle and process all sorts of queries. For example, asset graph use cases include queries such as “find all objects with a semantic label ‘cone’.” In these embodiments, for example, the uploaded digital asset 604 may be passed to a ViT or other vision language model that generates a bounding box and/or label for each object (e.g., a bounding box over the cone 604-1 with a semantic label “cone”). The output would be, for example, superimposed pixels or bounding box highlighting all the different cones within the digital asset 604.

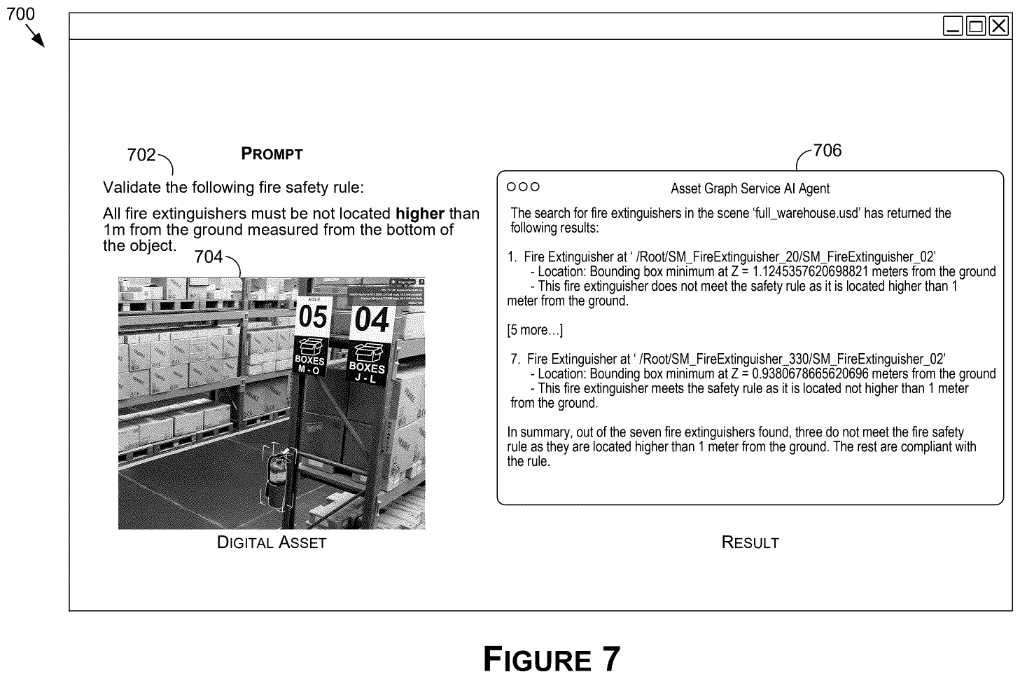

Some embodiments additionally or alternatively enforce spatial policies within a scene (e.g., due to safety regulations or engineering requirements), such as in FIG. 7. FIG. 7 is a screenshot of an example user interface page 700 illustrating the enforcement of spatial policies, according to some embodiments. FIG. 7 illustrates maintaining a minimum or maximum distances from certain objects or specifying a quantity or number of objects required. In FIG. 7, a user uploads the digital asset 704 and issues a prompt 702 “validate the following fire safety rules: all fire extinguishers must not be located higher than 1 m from the ground measured from the bottom of the object.” Upon querying an asset graph and processing a ViT, particular embodiments produce a result 706 “Fire extinguisher: location: bounding box minimum at Z=1.2456 . . . meters from the ground. This fire extinguisher does not meet the safety rule as it is located higher than 1 meter from the ground.” The system begins by identifying all fire extinguisher nodes in the asset graph. These nodes represent fire extinguishers in the scene and are connected by spatial relationships (such as position and bounding box data). Using ViT (Vision Transformer) or a similar vision-language model, the system analyzes the 3D spatial properties (such as the bounding box) of each fire extinguisher. The Z-coordinate of the bounding box minimum (which represents the position of the bottom of the fire extinguisher) is extracted. The system checks whether the Z-coordinate (which represents the height of the extinguisher) exceeds the 1-meter threshold. For example, if a fire extinguisher's bounding box minimum is located at Z=1.2456 meters, the system flags this extinguisher as non-compliant with the safety regulation. The system generates a report like: “Fire extinguisher: location: bounding box minimum at Z=1.2456 meters from the ground. This fire extinguisher does not meet the safety rule as it is located higher than 1 meter from the ground,” which may represent the result 706.

In another example, the prompt may be, “warehouse facilities must have at least one fire extinguisher per 100 m² of the facility.” The result may be “The total area of the warehouse is approximately 2693.45 square meters. According to the first safety rule that requires at least one fire extinguisher per 100 square meters, the warehouse should have at least 27 fire extinguishers. In yet another example of a prompt, “fire extinguishers must be located within 10m of each other.” The output result may be, “The validation of the first safety rule that fire extinguishers must be located within 10 meters of each other has been completed successfully. According to the results, there are no violations of this rule in the scene ‘full_warehouse.vsd.’ All fire extinguishers are positioned within the required distance from each other.”

In these embodiments, the system queries the asset graph for the total area of the warehouse. This area might be represented as a property or node within the graph structure, where spatial nodes represent the physical dimensions of the facility. After determining the total area (e.g., 2693.45 m²), the system applies the rule that mandates one fire extinguisher per 100 m². The system calculates the required number of fire extinguishers by dividing the total area by 100. For a warehouse of 2693.45 m², the system would determine that 27 fire extinguishers are required. The system generates a result such as: “The total area of the warehouse is approximately 2693.45 square meters. According to the first safety rule that requires at least one fire extinguisher per 100 square meters, the warehouse should have at least 27 fire extinguishers.” The system then counts the number of fire extinguisher nodes in the asset graph and compares the actual number to the required amount. If the count is less than 27, the system flags non-compliance.

In another example, the prompt may be “Fire extinguishers must be located within 10 meters of each other.” The system queries the asset graph to identify all fire extinguisher nodes and examines the spatial edges between these nodes. These edges represent the distance between the fire extinguishers in the 3D space. The system calculates the distance (e.g., Euclidian distance) between each pair of fire extinguishers by analyzing their coordinates in the scene. This is done by checking the spatial data stored in the graph nodes (e.g., X, Y, Z coordinates). If the distance between any two fire extinguishers exceeds 10 meters, the system identifies a violation. The system checks that all fire extinguishers in the scene are positioned within 10 meters of each other. If all distances meet the requirement, the system confirms that the rule is satisfied. The system produces a report like: “The validation of the first safety rule that fire extinguishers must be located within 10 meters of each other has been completed successfully. According to the results, there are no violations of this rule in the scene ‘full_warehouse.vsd.’ All fire extinguishers are positioned within the required distance from each other.”

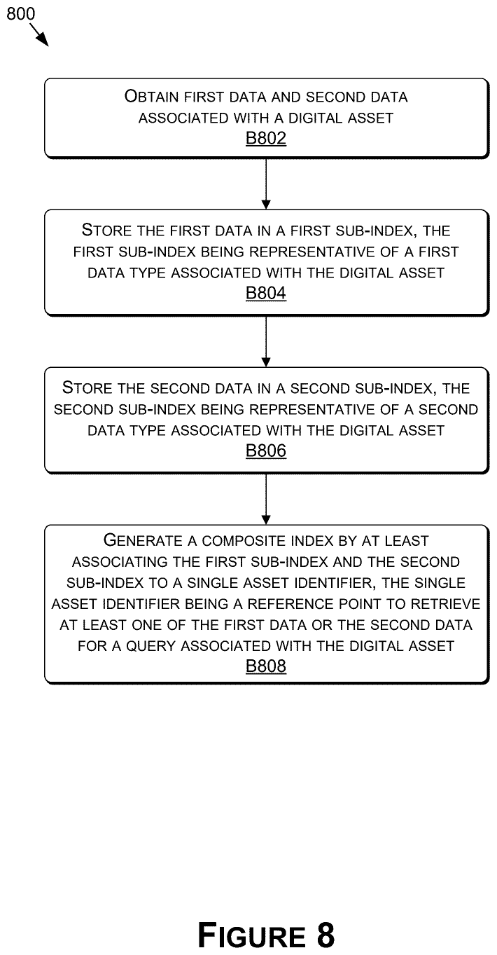

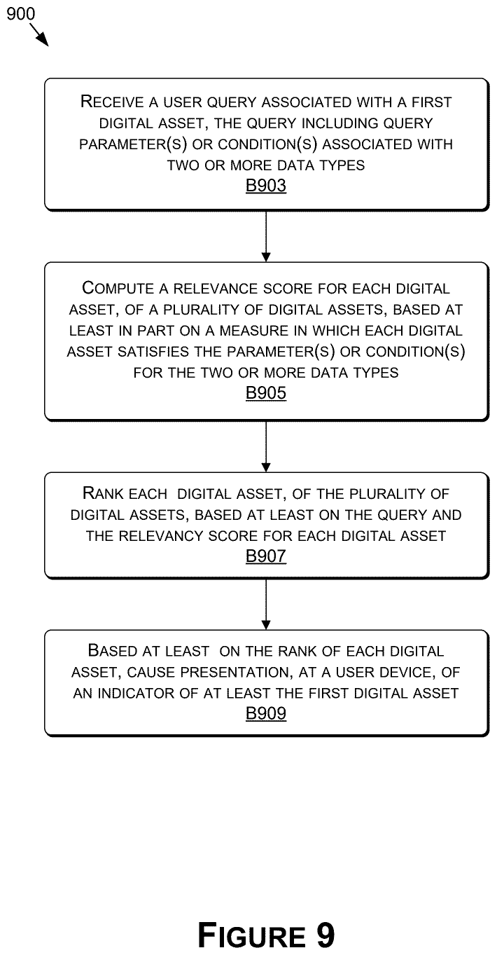

FIGS. 8 through 9 are flow diagrams of example methods. Each block of methods 800 and/or 900 described herein, comprises a computing process that may be performed using any combination of hardware, firmware, and/or software. For instance, various functions may be carried out by a processor executing instructions stored in memory, dedicated AI hardware accelerator circuitry, or the like. The processes may also be embodied as computer-usable instructions stored on computer storage media. The methods may be provided by a standalone application, a service or hosted service (standalone or in combination with another hosted service), or a plug-in to another product, to name a few. In addition, the process 400 is described, by way of example, with respect to the pipeline 100 of FIG. 1, pipeline 200 of FIG. 2, and/or pipeline of FIG. 3. However, these processes may additionally or alternatively be executed by any one system, or any combination of systems, including, but not limited to, those described herein.

FIG. 8 is a flow diagram of an example process 800 for building a composite index, according to some embodiments. In some embodiments, the process 800 represents a portion of the indexing pipeline as described with respect to FIG. 1. In some embodiments, additional or alternative functionality described in the indexing pipeline of FIG. 1 may be added to the process 800.

Per block 802, some embodiments obtain first data and second data associated with a digital asset. A “digital asset” (or “asset”) refers to any piece of content or data that exists in a digital format and is stored electronically. For example, a digital asset can include a 3D model, an image, a text description, a video, scene data, and/or a file (e.g., USD files) that represent objects or entities in a virtual environment. Digital assets may be associated with various types of metadata (such as visual attributes, spatial relationships, material properties) and can be indexed, searched, retrieved, and manipulated based on specific parameters or conditions.

Before the first data (and/or second data) is obtained, some embodiments first compute a multimodal embedding from an image that represents the digital asset. The multimodal embedding is a vector representation that encodes data from a text modality and an image modality into a shared embedding space. In these embodiments, the multimodal embedding is included in the first data. For example, when an image representing the digital asset is input into ta CLIP model, the image is passed through a vision encoder (e.g., a Vision Transformer (ViT) or CNN), which extracts visual features such as shapes, textures, colors, and spatial relationships within the image. Simultaneously, the associated text data (e.g., a description or label of the asset) is processed through a text encoder (e.g., a transformer-based model). Both the image and text are projected into a shared multimodal embedding space, where the model learns to map similar content from both modalities close to each other in the vector space. The result is a multimodal embedding, a vector that represents both the visual and textual features of the digital asset. This embedding can then be stored as part of the first data and used for tasks such as search, retrieval, or similarity matching based on either image or text queries.

Before the second data (and/or the first data) is obtained, some embodiments first convert a file in a universal scene descriptor (USD) data format into one or more thumbnails representing one or more image previews of one or more scenes of the file. Some embodiments also convert the one or more thumbnails into one or more respective embeddings, where at least one of the one or more thumbnails or the one or more respective embeddings are included in the second data. In an illustrative example, some embodiments first process the USD file through a rendering service. The USD file contains detailed 3D scene data, including objects, textures, lighting, and camera settings. The rendering service interprets this scene data, positioning the camera at predefined angles or based on user-specified viewpoints to generate 2D image previews (thumbnails) of the scene. These thumbnails are rendered using the scene's objects, materials, and lighting to provide accurate visual representations of the content within the USD file.

Once the thumbnails are generated, some embodiments pass each thumbnail through a vision encoder, such as a CLIP or Vision Transformer (ViT), to generate embeddings--vector representations that capture the visual features of the thumbnail (e.g., color, texture, object structure). Each embedding is then stored and associated with the respective thumbnail, allowing for efficient search and retrieval. At least one of the thumbnails or its respective embedding is included as part of the second data, enabling the system to utilize both the visual representation (thumbnail) and the semantic representation (embedding) of the scene for further processing or querying.

Before the first and/or second data is obtained, some embodiments first determine spatial data of elements in a scene in a universal scene descriptor (USD) data format. The spatial data includes at least one of, positions of the elements, orientations of the elements, hierarchical relationships between the elements, and spatial dependencies between the elements. Based on the spatial data, some embodiments then construct a graph data structure (e.g., the graph data structure 500 of FIG. 5) that includes graph data, the graph data being included in the first data. The USD file includes detailed 3D scene information, such as the positions, orientations, hierarchical relationships, and spatial dependencies between objects. Some embodiments first parse the USD file to access each element's transform matrices, which provide information about their positions and orientations within the 3D coordinate space. It also examines the hierarchical structure defined in the USD, which reveals the parent-child relationships between elements. Using this spatial data, the system constructs a graph data structure, where nodes represent the elements (e.g., objects or primitives), and edges represent their spatial relationships (e.g., proximity, dependencies, or hierarchy). This graph is then included in the first data and used for tasks like spatial queries, object interaction modeling, and scene validation.

In some embodiments, the “positions of the elements” refers to the 3D coordinates (X, Y, Z) that define where each element is located within the scene. For example, the position of a chair in a room might be at coordinates (2, 0, 1). In some embodiments, the “orientations of the elements” describes the rotation or alignment of an element in 3D space. This can include pitch, yaw, and roll, which determine the element's facing direction and how it's rotated around its axes. In some embodiments, the “hierarchical relationships between the elements” describe parent-child structures where one element is contained within or logically associated with another. For example, a lamp might be a child of a table, indicating that the lamp is positioned on or attached to the table. In some embodiments, the “spatial dependencies between the elements” refer to the interactions or constraints between elements based on their spatial configuration. For instance, a door and a wall may have a dependency where the door must be positioned within a certain distance of the wall, or two objects may need to maintain a specified distance for safety or functional reasons.

Before the first and/or second data is obtained, some embodiments obtain a user-defined natural language term and a set of images and then compute a multimodal embedding by mapping the user-defined natural language term and the set of images into a shared embedding space without changing any weights of a model, where the multimodal embedding is a vector representation that encodes data from the user-defined natural language term and the set of images into the shared embedding space, wherein the multimodal embedding being included in the second data.

In some of these embodiments, a Personalized Vision and Language” (PerVL) learning model can be used, aiming to enable large pretrained vision-language (V&L) models to handle personalized concepts, such as the user-defined natural language term. This approach lets models like CLIP, which are trained on vast datasets, work with specific, user-defined items (e.g., a favorite mug or unique toy) by using just a few images of these items for personalization. Traditional V&L models can recognize common concepts but struggle with unique, user-defined terms. The PerVL setup tackles this by allowing a model to learn new concepts (like “my toy wagon”) while keeping the original model's broad capabilities intact. The system avoids fine-tuning the model and instead expands its vocabulary to recognize personalized items.

In some embodiments, the model creates new embeddings for personalized items (e.g., user-defined terms and/or user provided images), which it can use in downstream tasks like retrieval and segmentation. Using only a few example images per personalized concept, the model distinguishes these items from generic concepts. Some embodiments use an approach called PALAVRA, which uses cycle-consistent loss to enhance generalization. The initial model is given a sentence(S) and an image (I). It expands the vocabulary (V) with new concepts, C={c1, . . . , ck}, where each concept is represented with embeddings.

With respect to training the Inversion Mapping (fθ), the mapping, fθ, connects CLIP's output to a point in the word embedding space W. Using a set of images ({zk} K) and captions, fθ learns embeddings for new words based on visual input. Cycle Consistency Loss ensures that the mapping retains similarity between visual and text representations. For each new concept, the model learns an initial embedding w0 by mapping the images of the personalized concept through fθ. With respect to fine-tuning, this embedding is then optimized for similarity to images representing the concept, while maintaining distance from “super-concept” embeddings (e.g., “mug” for “my mug”).

At inference time, the learned vocabulary, including user-specific concepts/user-defined terms/assets, is used with the unmodified CLIP model for tasks like image retrieval or segmentation. When encountering sentences with personalized tokens, the model leverages learned embeddings to recognize the items in complex scenes. This framework enables models to flexibly and robustly identify personalized items without modifying their foundational structures.

Put another way, this functionality describes a process where a system first obtains a user-defined term (such as “my toy unicorn”) and a set of corresponding images. Using the system's architecture, it computes a multimodal embedding, which is a vector representation of both the natural language term and the images. This embedding is computed by mapping both the user-defined term and the images into the shared embedding space used by a pretrained vision-language model (such as CLIP), without modifying the model's original weights. Instead of fine-tuning the model, the system relies on an external mapping function, fe, to generate these embeddings. The resulting multimodal embedding (e.g., the first or second data) encodes the personalized information and allows the system to integrate new concepts while preserving the model's zero-shot capabilities. This embedding can then be used for downstream tasks like retrieval or segmentation.

Before the first and/or second data is obtain, some embodiments first provide an image (e.g., a thumbnail of a USD scene) as input to a vision language model to generate metadata. The metadata including at least one of: a material property of an object in the image, a color of the object, an object type identifier of the object, scene context of the image, positioning of the object, or lighting and shading information associated with the image, where the metadata is included in the first data (and/or the second data). For example, the vision encoder within the model processes the image to extract visual features, including textures, colors, and object shapes, while the language model may process any associated text descriptions. The metadata generated includes information such as: the material property of objects (e.g., wood, metal), color (e.g., red or blue), an object type identifier (e.g., chair, table), the scene context (e.g., indoor living room), the positioning of objects relative to each other (e.g., object A is next to object B), and lighting and shading information (e.g., light source direction, shadow intensities). This metadata is then incorporated into the first data or second data, allowing the system to store semantically rich information about the scene for tasks like search, filtering, or validation.

Per block 804, some embodiments store the first data in a first sub-index, where the first sub-index is representative of a first data type associated with the digital asset. Per block 806, some embodiments store the second data in a second sub-index, where the second sub-index is representative of a second data type associated with the digital asset. In some embodiments, the first data type and the second data type are distinct data types among two or more of: visual data that describes attributes of the one or more digital assets, text data that describes the one or more digital assets in natural language, spatial data of the one or more digital assets, or material data that describes one or more material properties of the one or more digital assets.

In an example illustration of blocks 804 and 806, some embodiments processes a USD file and extracts first data such as the positions and orientations of objects in the scene. This data is stored in the first sub-index under the key of the digital asset's unique identifier (Asset ID), allowing queries to retrieve spatial information efficiently. Next, the system generates second data, such as an embedding or thumbnail of the scene, which is stored in the second sub-index under the same Asset ID. This allows the system to associate both types of data with the same asset while keeping them in sub-indices optimized for their respective data types.

Per block 808, some embodiments generate a composite index (e.g., the composite index 400 of FIG. 4) by at least associating the first sub-index and the second sub-index to a single asset identifier. The single asset identifier is a reference point to retrieve at least one of the first data or the second data for a query associated with the digital asset. The system generates the composite index by linking the first sub-index (e.g., spatial data) and the second sub-index (e.g., visual data) through a single asset identifier (Asset ID), which serves as a unique reference point for the digital asset. Each sub-index stores different data types independently but is connected to the same Asset ID. When a query is made, the system can retrieve data from either the first or second sub-index by using this Asset ID as a common key. The composite index serves as a higher-level abstraction that associates these separate sub-indices, allowing the system to efficiently access and combine data from multiple sub-indices based on the user's query. For example, a search for “red chairs near a table” can access both the spatial data (from the first sub-index) and the visual or color-related data (from the second sub-index) using the composite index linked by the Asset ID.

FIG. 9 is a flow diagram of an example process 900 for executing a query to return an indicator of at least a first digital asset, according to some embodiments. In some embodiments, the process 900 represents a portion of the search pipeline, as illustrated in FIG. 2. In some embodiments, one or more operations described with respect to FIG. 2 and/or FIG. 3 may be incorporated into the process 900 of FIG. 9.

Per block 903, some embodiments receive a query associated with a first digital asset, where the query includes one or more query parameters or conditions associated with two or more data types. In some embodiments, the two or more data types including at least two of visual data, text data, spatial data, or material data. For example, particular embodiments receive a query to find a red wooden chair that is positioned near a window in a room. This query includes conditions associated with two data types: visual data (the chair must be red and made of wood) and spatial data (the chair must be located near a window). Various embodiments process this query by first analyzing the visual properties of the assets (using the visual data to check for color and material) and then querying the spatial relationships (using spatial data to ensure the chair is positioned close to a window). The system retrieves and ranks digital assets based on how well they meet both the visual and spatial conditions specified in the query.

In some embodiments, the query includes one of: a set of natural language characters, an image or other visual input, or a multimodal query combining multiple criteria. For example, some embodiments receives a multimodal query where the user provides a text description-“modern black office chairs”-and uploads an image of a specific office layout. The query combines multiple criteria, including visual data (the chair must be black and modern in design, matching the uploaded image) and spatial data (the chairs must fit within the specific layout shown in the image). Particular embodiments process the text and image inputs simultaneously, using the visual features from the image and the text description to search for assets that match the appearance and spatial configuration required, returning ranked results based on the multimodal relevance.

Some embodiments compute a multimodal embedding from the query, where the multimodal embedding is a vector representation that encodes text data in the query and an image (e.g., a user-supplied image or training dataset image) into a shared embedding space, and wherein the computing of the relevance score for each asset is based at least in part on the computing of the multimodal embedding. For example, if the system receives a multimodal query that includes both text data (e.g., “modern black office chairs”) and an image (e.g., a picture of a specific office layout), it uses a vision-language model (VLM) like CLIP to compute a multimodal embedding. First, the text is processed through a text encoder, which converts the description into a vector representation. Simultaneously, the image is processed through a vision encoder, extracting visual features like object shapes, colors, and layout. Both the text and image embeddings are mapped into a shared embedding space, creating a multimodal embedding that represents the semantic meaning of the combined inputs. The system then compares this query embedding with precomputed embeddings of digital assets stored in the database (which represent attributes like color, material, and spatial configuration). A relevance score at block 905 is computed for each asset based on how closely its embedding aligns with the query's multimodal embedding, allowing the system to rank the assets by their relevance to the multimodal query.

Even if the query includes only text data and no image, some embodiments can still compute a multimodal embedding to find relevant images by leveraging a vision-language model (VLM) like CLIP. In this case, the text (e.g., “black office chairs”) is passed through the text encoder, which converts the text into a vector representation in the shared multimodal embedding space. Even though no image is provided in the query, the system can still compare this text embedding with precomputed image embeddings in the database, which represent the visual attributes of various assets. Since both the text and image embeddings are in the same shared embedding space, the system can directly measure the similarity between the text query embedding and the stored image embeddings. It then computes a relevance score at block 905 for each image based on how well the image's embedding aligns with the text embedding. This allows the system to return and rank a dataset of images that best match the textual description, even though no image was provided in the query.

Per block 905, some embodiments compute a relevance score for each digital asset, of a plurality of digital assets, base at least in part on a measure in which each digital asset satisfies the parameter(s) or condition(s) for the two or more data types. For example, some embodiments first map (e.g., via NLP, such as NER) the parameter(s) or condition(s) of the user query to two or more sub-indices, where each sub-index represents a specific modality (e.g., visual, text, spatial, or material data) associated with the digital asset. For each sub-index, the system retrieves data relevant to the query (e.g., visual features from an image sub-index or spatial relationships from a spatial sub-index). The system then computes a relevance score for each digital asset by evaluating how well the asset satisfies the query's parameters or conditions across these multiple modalities. In some embodiments, this involves computing similarity or matching scores within each sub-index and combining these scores to form an overall relevance score for each asset. The assets are then ranked based on their respective relevance scores.

In an illustrative example, for a query like “modern black office chairs near a window,” the system maps the query to the visual sub-index (to check for “modern” and “black” visual features) and to the spatial sub-index (to evaluate whether the chair is positioned near a window). It retrieves data from both sub-indices and computes a relevance score based on how well the asset matches both the visual and spatial conditions. For instance, a chair that is black and modern and located next to a window will score higher in relevance compared to a chair that matches the visual description.

In some embodiments, the system generates a multimodal profile for the first digital asset by first retrieving data from multiple sub-indices (e.g., visual, text, spatial) using a unique asset identifier that links all relevant data about the asset. A multimodal profile is the aggregated view of all the data retrieved from the sub-indices for a specific asset. When the system pulls data from each sub-index using the composite index, it combines this information into a single representation—this is the multimodal profile. The profile contains all relevant information about the asset from different modalities, such as its visual features, textual descriptions, and spatial properties. The asset identifier serves as a common key that allows the system to aggregate information from each sub-index. For example, it might retrieve the visual features (like color and material) from the visual sub-index, the textual description from the text sub-index, and the spatial position from the spatial sub-index. The system then combines this data into a unified multimodal profile, which captures a holistic view of the asset across different modalities.

In some embodiments, this multimodal profile is used to compute the asset's relevance score in response to a query, ensuring that all aspects of the asset are considered. For example, if the query specifies “black chair,” the system checks the visual sub-index for color and form, if the query specifies “office chair,” the system checks the text sub-index for object type or keywords, and if the query specifies “near a window,” the system checks the spatial sub-index for positional relationships. These partial scores are then aggregated into a total relevance score for the asset, which reflects how well it matches the query across all modalities. The assets are ranked based on their total relevance scores, ensuring that all aspects of the asset are considered during retrieval.

Some embodiments traverse (or cause a traversal of) a graph data structure to obtain spatial information associated with the query, where the computing of the relevance score is based at least on the traversing of the graph data structure. For example, some embodiments traverse the graph data structure by starting at the node representing the queried asset (e.g., a “chair”) and following the edges that represent spatial relationships between objects (e.g., “near,” “contains,” “next to”). Each node in the graph corresponds to an object in the scene, and the edges define their spatial dependencies or hierarchical positions. The system uses a graph traversal algorithm (e.g., depth-first search (DFS) or breadth-first search (BFS)) to explore connected nodes and gather spatial information relevant to the query. For example, if the query specifies “chairs near a table,” the system will traverse from the “chair” node, following edges labeled “near” to find connected “table” nodes. During traversal, the system calculates the spatial proximity between objects and evaluates how well these relationships match the query condition(s) or parameter(s). The computed spatial relevance is integrated into the overall relevance score, ensuring that spatial context is factored into the asset ranking.

Per block 907, some embodiments rank each digital asset, of the plurality of digital assets, based at least on the query and the relevance score for each digital asset. Accordingly, particular embodiments rank each digital asset by first calculating a relevance score for each asset based on how well it satisfies the query parameters across multiple modalities (e.g., visual, spatial, text). After computing the relevance scores, particular embodiments apply a ranking algorithm such as the Weighted Sum Model (WSM), where different modalities are assigned weights based on their importance to the query. For example, if a query emphasizes spatial proximity, spatial relevance might carry a higher weight. The system sums the weighted relevance scores for each asset, and the assets are then ranked in descending order by their total score.

In an illustrative example of ranking, for each asset, some embodiments compute the partial relevance scores for visual, spatial, and textual data (e.g., visual_score=0.8, spatial_score=0.7, textual_score=0.9). For a weighted sum, some embodiments apply weights to each score, such as 0.5*visual_score+0.3*spatial_score+0.2*textual_score. Some embodiments then perform a final ranking to rank assets based on their final weighted scores. For example, if a query prioritizes both visual (50%) and spatial (30%) data, an asset with a visual score of 0.8 and a spatial score of 0.7 would have a higher ranking than one that scores well on textual data but poorly on visual or spatial attributes. This ensures that assets are ranked based on their overall relevance to the query.

Per block 909, based at least on the rank of each digital asset, some embodiments cause presentation, at a user device, of an indicator of at least the first digital asset. For example, some embodiments select the top-ranked digital assets and prepare them for presentation by generating indicators, which could include thumbnails, natural language text descriptions, and/or metadata about the assets. Some embodiments format the indicators into a user-friendly interface, such as a grid or list view. For example, if the query was for red chairs, the top-ranked assets (based on their visual and spatial relevance scores) would be displayed with their thumbnails, names, and short descriptions on the user's device. In some instances, the system retrieves these visual and textual elements from the composite index and presents them, allowing the user to interact with or select the assets based on their ranking. For instance, if a specific red chair asset is ranked first, its thumbnail (from the visual sub-index) and description (from the text sub-index) are shown on the user's screen, enabling the user to view and select the most relevant result quickly.

### Example Language Models

In at least some embodiments, language models, such as large language models (LLMs), vision language models (VLMs), multi-modal language models (MMLMs), and/or other types of generative artificial intelligence (AI) may be implemented (e.g., within the VLM 121, embedding service 122/222, and/or the rendering service 120/220 of FIG. 1 and/or FIG. 2.). These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) —such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc.of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model —or version, instance, or agent-maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant-such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve-using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history-or at least a summary thereof-and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents-which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features-such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use-or capable of accessing or using-plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3rd party plugins) for help in processing the current input.

In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources-such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer 1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)-which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may use distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

One or more embodiments described below may be combined with one or more other embodiments. In an example embodiment, one or more processors comprise one or more processing units to: obtain first data and second data associated with a digital asset; store the first data using a first sub-index, the first sub-index being representative of a first data type associated with the digital asset; store the second data using a second sub-index, the second sub-index being representative of a second data type associated with the digital asset; and generate a composite index at least by associating a single asset identifier with the first sub-index and the second sub-index, the single asset identifier being a reference point to retrieve at least one of the first data or the second data for a query associated with the digital asset.

In some embodiments, the first data type and the second data type are distinct data types among two or more of: visual data that indicates attributes of the digital asset, text data that describes the digital asset in natural language, spatial data associated with the digital asset, or material data that describes one or more material properties of the digital asset.

In some embodiments, the one or more processing units are further to: receive a user query associated with the digital asset; and compute a relevance score for at least a subset of digital assets of a plurality of digital assets, based at least in part on a measure in which the first data from the first sub-index and the second data from the second sub-index satisfies specific parameters or conditions in the user query.

In some embodiments, the one or more processing units are further to: rank at least each asset of the subset of digital assets of the plurality of assets based at least on the relevancy score for each digital asset of the subset of digital assets; and based at least on the rank of each digital asset of the subset of digital assets, cause presentation, at a user device, of a representation of the digital asset.

In some embodiments, the user query includes at least one of: a set of natural language characters, an image or other visual input, or a multimodal query combining multiple criteria.

In some embodiments, the one or more processing units are further to: compute a multimodal embedding from an image that represents the digital asset, wherein the multimodal embedding comprises a vector representation that encodes data from a text modality and an image modality into a shared embedding space, wherein the multimodal embedding is included in the first data.

In some embodiments, the one or more processing units are further to: convert a file in a universal scene descriptor (USD) data format into one or more image previews of one or more scenes of the file; and convert the one or more image previews into one or more respective embeddings, wherein at least one of the one or more image previews or the one or more respective embeddings are included in the second data.

In some embodiments, the one or more processing units are further to: determine spatial data of one or more elements in a scene represented using a universal scene descriptor (USD) data format, the spatial data including at least one of: one or more positions of the elements, one or more orientations of the elements, one or more hierarchical relationships between the elements, and one or more spatial dependencies between the elements; and based on the spatial data, construct a graph data structure that includes graph data included in the first data.

In some embodiments, the one or more processing units are further to: obtain a user-defined natural language term and a set of images; and compute a multimodal embedding by mapping the user-defined natural language term and the set of images into a shared embedding space, wherein the multimodal embedding is a vector representation that encodes data from the user-defined natural language term and the set of images into the shared embedding space, wherein the multimodal embedding is included in the second data.

In some embodiments, the one or more processing units are further to: provide an image of the digital asset as input to a vision language model (VLM) to generate metadata, the metadata including at least one of: a material property of an object in the image, a color of the object, an object type identifier of the object, scene context of the image, positioning of the object, or lighting and shading information associated with the image, wherein the metadata is included in the first data.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system for generating synthetic data using one or more multi-modal language models; a system incorporating one or more virtual machines (VMs); a system implemented at least partially in a data center; or a system implemented at least partially using cloud computing resources.

In one embodiment, a data center system comprises a plurality of computing nodes, wherein two or more computing nodes of the plurality of computing nodes comprises one or more graphics processing units (GPUs) to: receive a query associated with a first digital asset, the query being associated with a plurality of data types and including at least one of: one or more query parameters or one or more conditions; compute a relevance score for at least a subset of digital assets of a set of digital assets based at least in part on a measure in which each digital asset of the subset of digital assets satisfies the one or more parameters or one or more conditions; compute a ranking for the subset of digital assets based at least on the query and the relevancy score corresponding to each digital asset of the subset of digital assets; and based at least on the ranking, cause presentation, at a user device, of an indicator of at least the first digital asset.

In some embodiments, the one or more computing nodes are further to: store an indication of the first digital asset in a composite index, the composite index comprising a plurality of sub-indices, each sub-index of the plurality of sub-indices being representative of a specific data type associated with the two or more data types; and associate the first digital asset with a unique asset identifier, the asset identifier linking data from each sub-index of the plurality of sub-indices to the first digital asset such that the first digital asset is retrievable based on the one or more query parameters or one or more conditions across the plurality of data types.

In some embodiments, the query includes one of: a set of natural language characters, an image or other visual input, or a multimodal query combining multiple criteria.

In some embodiments, the two or more computing nodes are further to: compute a multimodal embedding from the query, wherein the multimodal embedding is a vector representation that encodes text data in the query and an image into a shared embedding space, and wherein the computing of the relevance score for each asset is based at least in part on the computing of the multimodal embedding.

In some embodiments, the one or more computing nodes are further to: traverse a graph data structure to obtain spatial information associated with the query, wherein the relevance score is computed based at least on a traversal of the graph data structure.

In some embodiments, the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system for generating synthetic data using one or more multi-modal language models; or a system incorporating one or more virtual machines (VMs).

In an example embodiment, a method comprises: mapping one or more parameters or one or more conditions of a user query to a plurality of sub-indices, each sub-index of the plurality of sub-indices representing a respective modality associated with a digital asset; generating a multimodal profile for the digital asset by aggregating data obtained from the plurality of sub-indices using an asset identifier that represents the digital asset; computing a relevance score for the digital asset based on a measure in which the multimodal profile satisfies the one or more query parameters or conditions across each respective modality; and based at least on the relevance score, causing presentation of an indicator that represents at least the digital asset.

In some embodiments, the plurality of sub-indices include at least two or more of: visual data that indicates attributes of the digital asset, text data that describes the digital asset in natural language, spatial data associated with the digital asset, or material data that describes one or more material properties of the digital asset.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system for generating synthetic data using one or more multi-modal language models; a system incorporating one or more virtual machines (VMs); a system implemented at least partially in a data center; or a system implemented at least partially using cloud computing resources.

1. One or more processors comprising one or more processing units to:
obtain first data and second data associated with a digital asset;
store, to computer storage media, the first data using a first index, that represents an association between the first data and a first data type;
store, to the computer storage media, the second data using a second index that represents an association between the second data and a second data type; and
generate a composite index at least by associating, via at least one of: a pointer or a key, a single asset identifier to both the first index and the second index, the single asset identifier representing an identity of the digital asset and being a reference point to perform a computer retrieval operation of at least one of the first data or the second data from the computer storage media using at least one of the first index or the second index for a query associated with the digital asset.

2. The one or more processors of claim 1, wherein the first data type and the second data type are distinct data types among two or more of: visual data that indicates attributes of the digital asset, text data that describes the digital asset in natural language, spatial data associated with the digital asset, or material data that describes one or more material properties of the digital asset.

3. The one or more processors of claim 1, wherein the one or more processing units are further to:
receive a user query associated with the digital asset; and
compute a relevance score for at least a subset of digital assets of a plurality of digital assets, based at least in part on a measure in which the first data from the first index and the second data from the second sub-index satisfies specific parameters or conditions in the user query.

4. The one or more processors of claim 3, wherein the one or more processing units are further to:
rank at least each asset of the subset of digital assets of the plurality of assets based at least on the relevancy score for each digital asset of the subset of digital assets; and
based at least on the rank of each digital asset of the subset of digital assets, cause presentation, at a user device, of a representation of the digital asset.

5. The one or more processors of claim 3, wherein the user query includes at least one of: a set of natural language characters, an image or other visual input, or a multimodal query combining multiple criteria.

6. The one or more processors of claim 1, wherein the one or more processing units are further to:
compute a multimodal embedding from an image that represents the digital asset, wherein the multimodal embedding comprises a vector representation that encodes data from a text modality and an image modality into a shared embedding space, wherein the multimodal embedding is included in the first data.

7. The one or more processors of claim 1, wherein the one or more processing units are further to:
convert a file in a universal scene descriptor (USD) data format into one or more image previews of one or more scenes of the file; and
convert the one or more image previews into one or more respective embeddings, wherein at least one of the one or more image previews or the one or more respective embeddings are included in the second data.

8. The one or more processors of claim 1, wherein the one or more processing units are further to:
determine spatial data of one or more elements in a scene represented using a universal scene descriptor (USD) data format, the spatial data including at least one of: one or more positions of the elements, one or more orientations of the elements, one or more hierarchical relationships between the elements, and one or more spatial dependencies between the elements; and
based on the spatial data, construct a graph data structure that includes graph data included in the first data.

9. The one or more processors of claim 1, wherein the one or more processing units are further to:
obtain a user-defined natural language term and a set of images; and
compute a multimodal embedding by mapping the user-defined natural language term and the set of images into a shared embedding space, wherein the multimodal embedding is a vector representation that encodes data from the user-defined natural language term and the set of images into the shared embedding space, wherein the multimodal embedding is included in the second data.

10. The one or more processors of claim 1, wherein the one or more processing units are further to:
provide an image of the digital asset as input to a vision language model (VLM) to generate metadata, the metadata including at least one of: a material property of an object in the image, a color of the object, an object type identifier of the object, scene context of the image, positioning of the object, or lighting and shading information associated with the image, wherein the metadata is included in the first data.

11. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system for generating synthetic data using one or more multi-modal language models;
a system incorporating one or more virtual machines (VMs);
a system implemented at least partially in a data center; or
a system implemented at least partially using cloud computing resources.

12. A data center system comprising a plurality of computing nodes, wherein two or more computing nodes of the plurality of computing nodes comprises one or more graphics processing units (GPUs) to:
receive a query associated with a first digital asset, the query being a natural language text sequence that includes a first set of characters representing a first condition for a first modality and a second set of characters representing a second condition for a second modality;
compute a relevance score for at least a subset of digital assets of a set of digital assets by at least:
parsing the natural language text sequence to detect the first condition for the first modality and the second condition for the second modality; and
for each digital asset, of the subset of digital assets, performing a computer retrieval operation by mapping the first condition and the second condition to a respective composite index that associates, via at least one of a key or pointer, with a plurality of indices, each index, of the plurality of indices, representing data for a respective modality of the digital asset, wherein the computer retrieval operation accesses the data from the plurality of indices through the respective composite index;
for each digital asset of the subset of digital assets, based at least in part on a measure in which the data across all modalities of the respective digital asset satisfies the first condition and the second condition, generate the relevancy score;
compute a ranking for the subset of digital assets based at least on the query and the relevancy score; and
based at least on the ranking, cause presentation, at a user device, of an indicator of at least the first digital asset.

13. The data center system of claim 12, wherein the one or more computing nodes are further to:
store an indication of the first digital asset in the composite index, the composite index comprising a plurality of sub-indices, each sub-index of the plurality of sub-indices being representative of a specific data type associated with the two or more data types; and
associate the first digital asset with a unique asset identifier, the asset identifier linking data from each sub-index of the plurality of sub-indices to the first digital asset such that the first digital asset is retrievable based on the one or more query parameters or one or more conditions across the plurality of data types.

14. (canceled)

15. The data center of claim 12, wherein the two or more computing nodes are further to:
compute a multimodal embedding from the query, wherein the multimodal embedding is a vector representation that encodes text data in the query and an image into a shared embedding space, and wherein the computing of the relevance score for each asset is based at least in part on the computing of the multimodal embedding.

16. The data center of claim 12, wherein the one or more computing nodes are further to:
traverse a graph data structure to obtain spatial information associated with the query, wherein the relevance score is computed based at least on a traversal of the graph data structure.

17. The data center system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system for generating synthetic data using one or more multi-modal language models; or
a system incorporating one or more virtual machines (VMs).

18. A method comprising:
mapping one or more parameters or one or more conditions of a user query to a plurality of indices, each sub-index of the plurality of sub-indices representing an association of the data with a respective modality associated with a digital asset;
generating a multimodal profile for the digital asset by aggregating data obtained from the plurality of indices by associating an asset identifier to each index, of the plurality of indices, the asset identifier indicating an identity of the digital asset;
based at least on the associating of the asset identifier to each index, of the plurality of indices, computing a relevance score for the digital asset, the relevance score indicating a measure in which the multimodal profile satisfies the one or more query parameters or conditions across each respective modality; and
based at least on the relevance score, causing presentation of an indicator that represents at least the digital asset.

19. The method of claim 1, wherein the plurality of indices include at least two or more of: visual data that indicates attributes of the digital asset, text data that describes the digital asset in natural language, spatial data associated with the digital asset, or material data that describes one or more material properties of the digital asset.

20. The method of claim 18, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system for generating synthetic data using one or more multi-modal language models;
a system incorporating one or more virtual machines (VMs);
a system implemented at least partially in a data center; or
a system implemented at least partially using cloud computing resources.

21. The data center system of claim 12, wherein the generating of the relevancy score further comprises:
for each digital asset, of the subset of digital assets, generate at least a first partial score and a second partial score, the first partial score indicating a measure in which a respective digital asset satisfies the first condition for the first modality, the second partial score indicating a measure in which the respective digital asset satisfies the second condition for the second modality; and
for each digital asset, of the subset of digital assets, generating the relevancy score by aggregating the first partial score and the second partial score.
